(19) United States
(12) Patent Application Publication
(10) Pub. No.: US 2026/0117055 A1
(43) Pub. Date: Apr. 30, 2026

(54) POLYPROPYLENE COMPOSITION SUITABLE FOR AUTOMOTIVE APPLICATIONS

(71) Applicant: Borealis GmbH, Vienna (AT)

(72) Inventors: Daniela Mileva, Linz (AT); Doris Machl, Linz (AT); Tuan Anh Tran, Linz (AT); Jingbo Wang, Linz (AT)

(21) Appl. No.: 19/158,561

(22) PCT Filed: Aug. 22, 2023
(86) PCT No.: PCT/EP2023/073042

§ 371 Date: Aug. 21, 2025

(30) Foreign Application Priority Data
Feb. 28, 2023 (EP) 23158979.7

(51) Int. Cl. C08L 23/12; C08K 3/34

(52) U.S. Cl. CPC C08L 23/12; C08K 3/34; C08K 2003/343; C08K 2201/005; C08L 2205/025; C08L 2205/035; C08L 2207/02

(57) ABSTRACT

A composition suitable for automotive application obtainable by blending at least components (A), (B), (C), (D), (E) and (F): (A) from 5.0 to 40.0 wt.-%, preferably from 7.0 to 37.5 wt.-%, more preferably from 8.0 to 35.0 wt.-% of a first heterophasic propylene copolymer; (B) from 10.0 to 20.0 wt.-%, preferably from 12.5 to 19.0 wt.-%, more preferably from 14.0 to 18.0 wt.-% of a second heterophasic propylene copolymer; (C) from 15.0 wt.-% to 45.0 wt.-%, preferably from 17.5 to 42.5 wt.-%, more preferably from 20.0 to 40.0 wt.-% of a mixed-plastics polypropylene blend; (D) from 2.5 wt.-% to 15.0 wt.-%, preferably from 3.5 to 12.5 wt.-%, more preferably from 4.0 to 11.0 wt.-% of a mixed-plastics polyethylene blend; (E) from 2.5 wt.-% to 15.0 wt.-%, preferably from 3.5 to 12.5 wt.-%, more preferably from 4.0 to 11.0 wt.-% of an ethylene-based plastomer; and (F) from 2.5 wt.-% to 25.0 wt.-%, preferably from 3.5 to 22.0 wt.-%, more preferably from 4.0 to 20.0 wt.-% of an inorganic filler an article comprising the composition as described above or below in an amount of from 90 wt.-% to 100 wt.-%, and the use of the composition as described above or below for injection moulding of articles, preferably automotive articles, more preferably automotive interior articles.

The present invention relates to polypropylene compositions suitable especially for automotive applications comprising a mixed plastics polypropylene-based blend and a mixed plastics polyethylene-based blend.

### TECHNICAL BACKGROUND

Compositions suitable for the automotive industry typically contain one or more heterophasic polypropylene copolymer(s), and/or random heterophasic copolymers, and conventionally some inorganic filler.

One of the fundamental problems in polymer business is recycling. At the moment, the market for recyclates, particularly recyclates from household trash, commonly denoted PCR (‘post-consumer recyclate’) is somewhat limited. Starting from household trash, the sorting and separation processes employed will not allow preparing pure polymers, i.e. there will always be some contaminants, or the processes may even result in blends of different polymers. When it comes to polyolefins, which constitute the vast majority of the polymer fraction of the collected household trash, a perfect separation of polypropylene and polyethylene is hardly possible. Recycled polyolefin materials, particularly post-consumer recyclates, are conventionally cross-contaminated with non-polyolefin materials such as polyethylene terephthalate, polyamide, polystyrene or non-polymeric substances like wood, paper, glass or aluminum. Even worse, those post-consumer recycled polyolefin materials are readily available on a multi-ton scale but unfortunately have limited mechanical properties and frequently severe odor and/or emission problems. For interior applications in the automotive industry materials are required which show an excellent stiffness/toughness balance, homogeneous surface appearance, low scratch visibility and last but not least low emissions. Recently, the demand of the market has expanded in direction of using recycled polyolefins in blends with virgin polymers in order to fulfil the specific requirements of a final part.

European patent application EP 4 194 504 A1 is related to polypropylene compositions for automotive applications which contain mixed plastics polypropylene-based blends originating from post-consumer recycled polyolefin streams, ethylene-based plastomers and inorganic fillers, such as talc. These compositions show beneficial emissions, homogeneous surface appearance, scratch visibility and impact properties so that these compositions can replace fossil-based sophisticated virgin heterophasic polypropylene copolymers in interior automotive applications. However, these compositions include a rather low amount of recycled material of not more than 30 wt.-% in the compositions of the examples.

The present invention is based on the surprising finding that by carefully selecting the amounts of heterophasic propylene copolymer based virgin components HECO1 and HECO2 with different melt flow rates in polypropylene based compositions, which contain mixed plastics polypropylene-based blends, preferably originating from post-consumer recycled polyolefin streams, ethylene-based plastomers and inorganic fillers, such as talc, mixed plastics polyethylene-based blends, preferably originating from post-consumer recycled polyolefin streams, can be added without sacrificing any beneficial properties in behalf of emissions, homogeneous surface appearance, scratch visibility, stiffness and impact properties. To the contrary, a superior balance of properties especially in regard of homogeneous surface appearance, stiffness and impact strength can be observed.

### SUMMARY OF THE INVENTION

The present invention relates to a composition suitable for automotive applications obtainable by blending at least components (A), (B), (C), (D), (E) and (F):
(A) from 5.0 to 40.0 wt.-%, preferably from 7.0 to 37.5 wt.-%, more preferably from 8.0 to 35.0 wt.-% of a first heterophasic propylene copolymer;
(B) from 10.0 to 20.0 wt.-%, preferably from 12.5 to 19.0 wt.-%, more preferably from 14.0 to 18.0 wt.-% of a second heterophasic propylene copolymer;
(C) from 15.0 wt.-% to 45.0 wt.-%, preferably from 17.5 to 42.5 wt.-%, more preferably from 20.0 to 40.0 wt.-% of a mixed-plastics polypropylene blend;
(D) from 2.5 wt.-% to 15.0 wt.-%, preferably from 3.5 to 12.5 wt.-%, more preferably from 4.0 to 11.0 wt.-% of a mixed-plastics polyethylene blend;
(E) from 2.5 wt.-% to 15.0 wt.-%, preferably from 3.5 to 12.5 wt.-%, more preferably from 4.0 to 11.0 wt.-% of an ethylene-based plastomer; and
(F) from 2.5 wt.-% to 25.0 wt.-%, preferably from 3.5 to 22.0 wt.-%, more preferably from 4.0 to 20.0 wt.-% of an inorganic filler;
whereby all percentages refer to the total composition, and whereby the first heterophasic propylene copolymer (A) comprises a matrix phase and an elastomer phase dispersed therein and has
   a melt flow rate (MFR₂), determined according to ISO 1133 at 230° C. and 2.16 kg, in the range from 90 to 250 g/10 min; and
   an intrinsic viscosity, determined according to DIN ISO 1628/1, of the soluble fraction (iV(SF)), according to CRYSTEX QC analysis, in the range from 2.00 to 4.00 dl/g;
the second heterophasic propylene copolymer (B) comprises a matrix phase and an elastomer phase dispersed therein and has
   a melt flow rate MFR₂, determined according to ISO 1133 at 230° C. and 2.16 kg, in the range from 3.0 to 30 g/10 min and
   an intrinsic viscosity, determined according to DIN ISO 1628/1, of the soluble fraction (iV(SF)), according to CRYSTEX QC analysis, in the range from 4.10 to 10.00 dl/g;
the mixed-plastics polypropylene blend (C) has
   a crystalline fraction (CF) content determined according to CRYSTEX QC analysis in the range from 85.0 to 96.0 wt.-%, preferably in the range from 86.5 to 95.5 wt.-%, and
   a soluble fraction (SF) content determined according to CRYSTEX QC analysis in the range from 4.0 to 15.0 wt.-%, preferably in the range from 4.5 to 13.5 wt.-%, whereby
   said crystalline fraction (CF) has an ethylene content (C2(CF)), as determined by FT-IR spectroscopy calibrated by quantitative ¹³C-NMR spectroscopy, in the range from 1.0 to 10.0 wt.-%, preferably in the range of 1.5 to 9.5 wt.-%; and
   said soluble fraction (SF) has an intrinsic viscosity (iV(SF)) in the range from 0.9 to 2.1 dl/g, preferably in the range of 1.0 to 2.0 dl/g, more preferably in the range of 1.1 to 1.9 dl/g;
the mixed-plastics polyethylene blend (D) has
   a melt flow rate MFR₂ of 0.1 to 5.0 g/10 min, preferably 0.2 to 2.5 g/10 min, determined according to ISO 1133 at 190° C. and 2.16 kg; and
   a density of 970 to 990 kg/m³, preferably from 975 to 985 kg/m³, determined according to ISO 1183;
the ethylene based plastomer (E) being a copolymer of ethylene with comonomer units selected from alpha-olefins having from 3 to 12 carbon atoms, preferably from alpha-olefins having from 4 to 10 carbon atoms, most preferably from 1-octene, has
   a melt flow rate MFR₂ of 0.2 to 2.5 g/10 min, preferably 0.3 to 2.0 g/10 min, determined according to ISO 1133 at 190° C. and 2.16 kg; and
   a density of 850 to 870 kg/m³, preferably from 855 to 865 kg/m³, determined according to ISO 1183; and
the composition has a melt flow rate MFR₂, determined according to ISO 1133 at 230° C. and 2.16 kg, in the range from 5.0 to less than 20.0 g/10 min, preferably from 6.5 to 19.0 g/10 min, more preferably from 7.5 to 17.5 g/10 min.

Further, the present invention relates to an article comprising the composition as described above or below in an amount of from 90 to 100 wt.-%.

Still further, the present invention relates to the use of the composition as described above or below for injection moulding of articles, preferably automotive articles, more preferably automotive interior articles.

### Definitions

Unless defined otherwise, all technical and scientific terms used herein have the same meaning as commonly understood by one of ordinary skill in the art to which the invention pertains. Although, any methods and materials similar or equivalent to those described herein can be used in practice for testing of the present invention, the preferred materials and methods are described herein. In describing and claiming the present invention, the following terminology will be used in accordance with the definitions set out below. Unless clearly indicated otherwise, use of the terms “a,” “an,” and the like refers to one or more.

Mixed plastics is defined as the presence of low amounts of compounds usually not found in virgin polypropylene blends such as polystyrenes, polyamides, polyesters, wood, paper, limonene, aldehydes, ketones, fatty acids, metals, and/or long term decomposition products of stabilizers. Virgin polypropylene blends denote blends as directly originating from the production process without intermediate use.

As a matter of definition “mixed plastics” can be equated with detectable amounts of polystyrene and/or polyamide-6 and/or limonene and/or fatty acids.

Mixed plastics thereby can originate from both post-consumer waste and industrial waste, as opposed to virgin polymers. Post-consumer waste refers to objects having completed at least a first use cycle (or life cycle), i.e. having already served their first purpose. In contrast to that, industrial waste refers to manufacturing scrap, respectively conversion scrap, which does not normally reach a consumer.

The term “virgin” denotes the newly produced materials and/or objects prior to their first use, which have not already been recycled.

The term “recycled material” such as used herein denotes materials reprocessed from “recycled waste”.

A polymer blend is a mixture of two or more polymeric components. In general, the blend can be prepared by mixing the two or more polymeric components. A suitable mixing procedures known in the art is post-polymerization blending.

Post-polymerization blending can be dry blending of polymeric components such as polymer powders and/or compounded polymer pellets or melt blending by melt mixing the polymeric components.

A mixed-plastic polypropylene blend indicates that the blend predominantly comprises polypropylene; however, small amounts of other plastic are present.

A mixed-plastic polyethylene blend indicates that the blend predominantly comprises polyethylene; however, small amounts of other plastic are present.

Recyclate blends, in particular post-consumer recyclate blends, are almost always mixed-plastic blends, which reflects the efficiency of the sorting in state of the art recycling processes.

A polypropylene means a polymer being composed of units derived from propylene in an amount of more than 50 mol-%.

A polyethylene means a polymer being composed of units derived from ethylene in an amount of more than 50 mol-%.

A propylene homopolymer is a polymer, which essentially consists of propylene monomer units. Due to impurities especially during commercial polymerization processes a propylene homopolymer can comprise up to 0.1 mol % comonomer units, preferably up to 0.05 mol % comonomer units and most preferably up to 0.01 mol % comonomer units.

The term “elastomer” denotes a natural or synthetic polymer having elastic properties. The term “plastomer” denotes a natural or synthetic polymer having which combines qualities of elastomers and plastics, such as rubber-like properties with the processing ability of plastic. An ethylene based plastomer means a plastomer being composed of units derived from ethylene in an amount of more than 50 mol %.

The presence of a heterophasic nature can be easily determined by the number of glass transition points, like in dynamic-mechanical analysis (DMA), and/or high resolution microscopy, like scanning electron microscopy (SEM), transmission electron microscopy (TEM) or atomic force microscopy (AFM).

The term “XCS” refers to the xylene cold soluble fraction (XCS wt.-%) determined at 25° C. according to ISO 16152. The term “XCI” refers to the xylene cold insoluble fraction (XCI wt.-%) determined at 25° C. according to ISO 16152.

Reactor blend is a blend originating from the production in two or more reactors coupled in series or in a reactor having two or more reaction compartments. A reactor blend may alternatively result from blending in solution. A reactor blend stands in contrast to a compound as produced by melt extrusion. If not indicated otherwise “%” refers to weight-% (wt.-%).

### DETAILED DESCRIPTION

### Composition

In a first aspect, the present invention relates to a composition suitable for automotive applications obtainable by blending at least components (A), (B), (C), (D), (E) and (F):
(A) from 5.0 to 40.0 wt.-%, preferably from 7.0 to 37.5 wt.-%, more preferably from 8.0 to 35.0 wt.-% of a first heterophasic propylene copolymer;
(B) from 10.0 to 20.0 wt.-%, preferably from 12.5 to 19.0 wt.-%, more preferably from 14.0 to 18.0 wt.-% of a second heterophasic propylene copolymer;
(C) from 15.0 wt.-% to 45.0 wt.-%, preferably from 17.5 to 42.5 wt.-%, more preferably from 20.0 to 40.0 wt.-% of a mixed-plastics polypropylene blend;
(D) from 2.5 wt.-% to 15.0 wt.-%, preferably from 3.5 to 12.5 wt.-%, more preferably from 4.0 to 11.0 wt.-% of a mixed-plastics polyethylene blend;
(E) from 2.5 wt.-% to 15.0 wt.-%, preferably from 3.5 to 12.5 wt.-%, more preferably from 4.0 to 11.0 wt.-% of an ethylene-based plastomer; and
(F) from 2.5 wt.-% to 25.0 wt.-%, preferably from 3.5 to 22.0 wt.-%, more preferably from 4.0 to 20.0 wt.-% of an inorganic filler;
whereby all percentages refer to the total composition, and whereby the first heterophasic propylene copolymer (A) comprises a matrix phase and an elastomer phase dispersed therein and has
   a melt flow rate (MFR₂), determined according to ISO 1133 at 230° C. and 2.16 kg, in the range from 90 to 250 g/10 min; and
   an intrinsic viscosity, determined according to DIN ISO 1628/1, of the soluble fraction (iV(SF)), according to CRYSTEX QC analysis, in the range from 2.00 to 4.00 dl/g;
the second heterophasic propylene copolymer (B) comprises a matrix phase and an elastomer phase dispersed therein and has
   a melt flow rate MFR₂, determined according to ISO 1133 at 230° C. and 2.16 kg, in the range from 3.0 to 30 g/10 min and
   an intrinsic viscosity, determined according to DIN ISO 1628/1, of the soluble fraction (iV(SF)), according to CRYSTEX QC analysis, in the range from 4.10 to 10.00 dl/g;
the mixed-plastics polypropylene blend (C) has
   a crystalline fraction (CF) content determined according to CRYSTEX QC analysis in the range from 85.0 to 96.0 wt.-%, preferably in the range from 86.5 to 95.5 wt.-%, and
   a soluble fraction (SF) content determined according to CRYSTEX QC analysis in the range from 4.0 to 15.0 wt.-%, preferably in the range from 4.5 to 13.5 wt.-%, whereby
   said crystalline fraction (CF) has an ethylene content (C2(CF)), as determined by FT-IR spectroscopy calibrated by quantitative ¹³C-NMR spectroscopy, in the range from 1.0 to 10.0 wt.-%, preferably in the range of 1.5 to 9.5 wt.-%; and
   said soluble fraction (SF) has an intrinsic viscosity (iV(SF)) in the range from 0.9 to 2.1 dl/g, preferably in the range of 1.0 to 2.0 dl/g, more preferably in the range of 1.1 to 1.9 dl/g;
the mixed-plastics polyethylene blend (D) has
   a melt flow rate MFR₂ of 0.1 to 5.0 g/10 min, preferably 0.2 to 2.5 g/10 min, determined according to ISO 1133 at 190° C. and 2.16 kg; and
   a density of 970 to 990 kg/m³, preferably from 975 to 985 kg/m³, determined according to ISO 1183;
the ethylene based plastomer (E) being a copolymer of ethylene with comonomer units selected from alpha-olefins having from 3 to 12 carbon atoms, preferably from alpha-olefins having from 4 to 10 carbon atoms, most preferably from 1-octene, has
   a melt flow rate MFR₂ of 0.2 to 2.5 g/10 min, preferably 0.3 to 2.0 g/10 min, determined according to ISO 1133 at 190° C. and 2.16 kg; and
   a density of 850 to 870 kg/m³, preferably from 855 to 865 kg/m³, determined according to ISO 1183; and
the composition has a melt flow rate MFR₂, determined according to ISO 1133 at 230° C. and 2.16 kg, in the range from 5.0 to less than 20.0 g/10 min, preferably from 6.5 to 19.0 g/10 min, more preferably from 7.5 to 17.5 g/10 min.

The composition suitable for automotive application according to the present invention is particularly suitable for injection moulding of articles to be used on the interior of vehicles.

In a preferred embodiment, the composition suitable for automotive applications is obtainable by blending at least the components (A), (B), (C), (D), (E) and (F):
(A) from 5.0 to 40.0 wt.-%, preferably from 7.0 to 37.5 wt.-%, more preferably from 8.0 to 35.0 wt.-% of the first heterophasic propylene copolymer;
(B) from 10.0 to 20.0 wt.-%, preferably from 12.5 to 19.0 wt.-%, more preferably from 14.0 to 18.0 wt.-% of the second heterophasic propylene copolymer;
(C) from 15.0 wt.-% to 45.0 wt.-%, preferably from 17.5 to 42.5 wt.-%, more preferably from 20.0 to 40.0 wt.-% of the mixed-plastics polypropylene blend;
(D) from 2.5 wt.-% to 15.0 wt.-%, preferably from 3.5 to 12.5 wt.-%, more preferably from 4.0 to 11.0 wt.-% of the mixed-plastics polyethylene blend;
(E) from 2.5 wt.-% to 15.0 wt.-%, preferably from 3.5 to 12.5 wt.-%, more preferably from 4.0 to 11.0 wt.-% of the ethylene-based plastomer; and
(F) from 2.5 wt.-% to less than 12.5 wt.-%, preferably from 3.5 to 12.0 wt.-%, more preferably from 4.0 to 11.0 wt.-% of the inorganic filler.

The composition preferably comprises a total amount of recyclate blends, preferably the combined amount of the mixed-plastics polypropylene blend (C) and the mixed-plastics polyethylene blend (D) of from 25.0 to 60.0 wt.-%, more preferably from 30.0 to 55.0 wt.-%, still more preferably from 32.5 to 50.0 wt.-%, based on the total weight of the composition.

The composition suitable for automotive application according to the present invention has one or more of the following characteristics: The composition has a melt flow rate MFR₂ (230° C., 2.16 kg, ISO 1133) of from 5.0 to less than 20.0 g/10 min, preferably from 6.5 to 19.0 g/10 min, more preferably from 7.5 to 17.5 g/10 min.

The composition can be characterized by CRYSTEX QC analysis. In the CRYSTEX QC analysis a crystalline fraction (CF) and a soluble fraction (SF) are obtained which can be quantified and analysed in regard of the monomer and comonomer content as well as the intrinsic viscosity (iV).

The composition preferably shows one or all of the following properties in the CRYSTEX QC analysis:
a crystalline fraction (CF) content determined according to CRYSTEX QC analysis in the range from 65.0 to 85.0 wt.-%, preferably 70.0 to 80.0 wt.-%, and
a soluble fraction (SF) content determined according to CRYSTEX QC analysis in the range from 15.0 to 35.0 wt.-%, preferably 20.0 to 30.0 wt.-%.

Generally, the crystalline fraction (CF) content and the soluble (SF) content of a composition only relate to its polymeric components, i.e. without other components, which are insoluble and therefore not part of the dissolution and crystallization cycles as described below in the determination method, such as the inorganic filler (F).

The crystalline fraction (CF) content and the soluble (SF) content therefore are based on the weight amount of the polymeric components of the composition.

Said crystalline fraction (CF) preferably has one or more, preferably all of the following properties:
an ethylene content (C2(CF)), as determined by FT-IR spectroscopy calibrated by quantitative ¹³C-NMR spectroscopy, of 7.5 to 25.0 wt.-%, more preferably 9.0 to 22.5 wt.-%; and/or
an intrinsic viscosity (iV(CF)), as measured in decalin according to DIN ISO 1628/1 at 135° C., of less than 2.0 dl/g, more preferably from 1.2 to 1.9 dl/g.

Said soluble fraction (SF) preferably has one or more, preferably all of the following properties:
an ethylene content (C2(SF)), as determined by FT-TR spectroscopy calibrated by quantitative ¹³C-NMR spectroscopy, in the range from 45 to 65 wt.-%, more preferably 50 to 60 wt.-%; and/or
an intrinsic viscosity (iV(SF)), as measured in decalin according to DIN ISO 1628/1 at 135° C., of more than 2.1 dl/g, more preferably from 2.2 to 3.5 dl/g.

The composition preferably comprises units derived from ethylene in an amount of from 17.5 to 30.0 wt.-%, more preferably 19.0 to 25.0 wt.-%.

Additionally, the composition preferably has an intrinsic viscosity iV of from 1.40 to 2.40 dl/g, more preferably from 1.60 to 2.20 dl/g.

Further, the composition preferably has a ratio of the intrinsic viscosities of the soluble fraction and crystalline fraction (iV(SF)/iV(CF)) of more than 1.0, more preferably from 1.10 to 2.00, still more preferably from 1.25 to 1.75.

Still further, the composition preferably has a ratio of the ethylene contents of the soluble fraction and crystalline fraction (C2(SF)/C2(CF)) of not more than 7.5, preferably from 1.5 to 6.5, more preferably from 2.5 to 6.0.

The composition according to the invention preferably shows a superior balance of properties in regard of flowability, as can be seen from the melt flow rate described above, impact properties, stiffness, such as in in regard of the tensile and flexural properties, and especially emissions, such as in regard of LBS and HBS volatiles and fogging.

The composition preferably has a flexural modulus of from 1400 MPa to 2200 MPa, more preferably from 1500 MPa to 2000 MPa.

Further, the composition preferably has a tensile modulus of from 1200 MPa to 2200 MPa, more preferably from 1300 MPa to 2000 MPa.

Additionally, the composition preferably has a tensile stress at yield of from 15 to 35 MPa, more preferably from 18 to 30 MPa.

Furthermore, the composition preferably has an elongation at break of from 350 to 500%, more preferably from 375 to 475%.

Further, the composition preferably has a Charpy Notched Impact Strength at 23° C. (CNIS at 23° C.) of from 30.0 kJ/m² to 75.0 kJ/m², more preferably from 40.0 to 70.0 kJ/m².

Further, the composition preferably has a Charpy Notched Impact Strength at −20° C. (CNIS at −20° C.) of from 2.5 kJ/m² to 10.0 kJ/m², more preferably from 3.5 to 7.5 kJ/m².

Additionally, the composition preferably has a stiffness-impact coefficient Tensile Modulus*Charpy NIS (+23° C.) of more than 40000 MPa*kJ/m², more preferably from 50000 to 150000 MPa*kJ/m², still more preferably from 67500 to 135000 MPa*kJ/m², yet more preferably from 75000 to 125000 MPa*kJ/m².

Further, the composition preferably has a content of low boiling substances (LBS), determined by screening of organic emissions by thermo-desorption analysis, in the range from 5 to 100 μg/g, more preferably from 10 to 75 μg/g.

Still further, the composition preferably has a content of high boiling substances (HBS) determined by screening of organic emissions by thermo-desorption analysis, in the range from 50 to 300 μg/g, preferably from 100 to 250 μg/g.

Furthermore, the composition preferably has an amount of fogging, determined according to the gravimetric method DI 75201:2011-11, method B, in the range from 0.05 to 0.75 mg, more preferably from 0.15 to 0.50 mg.

The composition of the invention mandatorily comprises components (A), (B), (C), (D), (E) and (F) as described above or below in the accordantly described amounts.

Components (A), (B), (C), (D), (E) and (F) preferably make up from 85.0 to 100 wt.-%, more preferably from 90.0 to 99.9 wt.-% of the composition.

The composition preferably further comprises a pigment masterbatch in an amount of from 0.5 to 10.0 wt.-%, more preferably in the range from 2.0 to 10.0 wt.-%, most preferably in the range from 4.0 to 10.0 wt.-%, based on the total weight of the composition.

The composition preferably further comprises additives in an amount of up to 3.0 wt %, more preferably in an amount of from 0.1 to 3.0 wt %, still more preferably in an amount of from 0.5 to 2.5 wt %, based on the total weight of the composition.

Typical additives would be selected from antioxidants, slip agents, nucleating agents, anti-scratch agents, anti-scorch agents, metal deactivators, UV-stabilisers, acid scavengers, lubricants, anti-static agents and the like, as well as combinations thereof. These additives are well known in the polymer industry and their use will be familiar to the skilled practitioner. Any additives, which are present, may be added as an isolated raw material or in a mixture with a carrier polymer, i.e. in a so-called master batch.

In a preferred embodiment, the composition consists of components (A), (B), (C), (D), (E) and (F), optionally a pigment masterbatch and optionally additives, all as described above or below.

The composition according to the invention is usually prepared by melt blending the components (A), (B), (C), (D), (E) and (F), optional pigment masterbatch and optional additives. Melt blending equipment and conditions are within the common skills in the art.

In particular, it is preferred to use a conventional compounding or blending apparatus, e.g. a Banbury mixer, a 2-roll rubber mill, Buss-co-kneader or a twin-screw extruder. More preferably, mixing is accomplished in a co-rotating twin-screw extruder.

The polymer materials, such as the composition according to the invention, recovered from the extruder are usually in the form of pellets.

### First Heterophasic Propylene Copolymer (A)

The first heterophasic propylene copolymer (A) comprises a matrix phase and an elastomer phase dispersed therein.

The first heterophasic propylene copolymer (A) has a melt flow rate MFR₂ (230° C., 2.16 kg, ISO 1133) of 90 to 250 g/10 min, preferably 95 to 200 g/10 min, more preferably 97 to 175 g/10 min.

The first heterophasic propylene copolymer (A) can be characterized by the CRYSTEX QC analysis. In the CRYSTEX QC analysis a crystalline fraction (CF) and a soluble fraction (SF) are obtained which can be quantified and analysed in regard of the monomer and comonomer content as well as the intrinsic viscosity (iV).

The first heterophasic propylene copolymer (A) preferably shows one or all of the following properties in the CRYSTEX QC analysis:
a crystalline fraction (CF) content determined according to CRYSTEX QC analysis in the range from 80.5 to 92.0 wt.-%, preferably from 82.0 to 90.0 wt.-%, more preferably from 83.0 to 86.0 wt.-%; and
a soluble fraction (SF) content determined according to CRYSTEX QC analysis in the range from 8.0 to 19.5 wt.-%, preferably in the range from 10.0 to 18.0 wt.-%, more preferably in the range from 13.0 to 17.0 wt.-%.

Said crystalline fraction (CF) preferably has one or more, preferably all of the following properties:
an ethylene content (C2(CF)), as determined by FT-IR spectroscopy calibrated by quantitative ¹³C-NMR spectroscopy, of 0.1 to 5.0 wt.-%, preferably of 0.2 to 4.0 wt. %, more preferably of 0.5 to 3.0 wt %; and/or
an intrinsic viscosity (iV(CF)), as measured in decalin according to DIN ISO 1628/1 at 135° C., of less than 1.8 dl/g, preferably of 0.8 to 1.6 dl/g, more preferably of 0.9 to 1.3 dl/g.

Said soluble fraction (SF) preferably has one or more, preferably all of the following properties:
an ethylene content (C2(SF)), as determined by FT-TR spectroscopy calibrated by quantitative ¹³C-NMR spectroscopy, in the range from 25.0 to 45.0 wt.-%, preferably from 27.5 to 43.0 wt.-%, more preferably from 30.0 to 42.0 wt.-%; and/or
an intrinsic viscosity (iV(SF)), as measured in decalin according to DIN ISO 1628/1 at 135° C., of 1.50 to 4.00 dl/g, preferably of 1.60 to 3.00 dl/g, more preferably of 1.70 to 2.50 dl/g.

In a specific embodiment the first heterophasic propylene copolymer (A) preferably has an intrinsic viscosity (iV(SF)), as measured in decalin according to DIN ISO 1628/1 at 135° C., of 2.00 to 4.00 dl/g, preferably of 2.30 to 3.70 dl/g, more preferably of 2.50 to 3.30 dl/g.

The first heterophasic propylene copolymer (A) preferably comprises units derived from ethylene in an amount of from 2.5 to 12.5 wt.-%, more preferably from 4.0 to 10.0 wt.-%, still more preferably from 5.0 to 7.5 wt.-%.

The ratio of the intrinsic viscosities of the soluble fraction and crystalline fraction (IV(SF)/IV(CF)) is preferably more than 1.0, more preferably of 1.3 to 2.5, still more preferably of 1.4 to 2.0.

The ratio of the ethylene contents of the soluble fraction and crystalline fraction (C2(SF)/C2(CF)) is preferably in the range of from 7.5 to 22.5, more preferably in the range of from 10.0 to 20.0, still more preferably in the range of from 15.0 to 17.5.

The first heterophasic propylene copolymer (A) further preferably has one or more, preferably all, of the following properties:
a melting temperature Tm of from 155 to 175° C., more preferably from 157 to 172° C., still more preferably from 160 to 170° C.; and/or
a crystallization temperature Tc of from 115 to 135° C., more preferably from 117 to 132° C., still more preferably from 119 to 130° C.,
all of said temperatures being determined by differential scanning calorimetry (DSC).

The first heterophasic propylene copolymer (A) preferably shows a good balance of properties in regard of mechanical properties, impact properties and heat stability: The first heterophasic propylene copolymer (A) preferably has a tensile modulus of from 1200 to 1600 MPa, more preferably from 1250 to 1550 MPa, still more preferably from 1300 to 1500 MPa.

Further, the first heterophasic propylene copolymer (A) preferably has a Charpy Notched Impact Strength at 23° C. (CNIS at 23° C.) of from 1.0 to 7.5 kJ/m², more preferably from 2.0 to 5.0 kJ/m².

It is preferred that the first heterophasic propylene copolymer (A) consists of propylene units and ethylene units only.

Although not measured, the content of units derived from propylene (C3) in the soluble fraction (SF) preferably adds up to 100 wt.-% with the content of units derived from ethylene (C2) in the soluble fraction (SF).

The content of units derived from propylene (C3) in the soluble fraction (SF) is preferably 55.0 to 75.0 wt.-%, more preferably 57.0 to 72.5 wt.-%, still more preferably 58.0 to 70.0 wt.-%.

Although not measured the content of units derived from propylene (C3) in the crystalline fraction (CF) preferably adds up to 100 wt.-% with the content of units derived from ethylene (C2) in the crystalline fraction (CF).

The content of units derived from propylene (C3) in the crystalline fraction (CF) is preferably 95.0 to 99.9 wt.-%, more preferably 96.0 to 99.8 wt.-%, still more preferably 97.0 to 99.5 wt.-%. The total content of units derived from propylene (C3) in the first heterophasic polypropylene copolymer (A) is preferably 87.5 to 97.5 wt.-%, more preferably 90.0 to 96.0 wt.-%, still more preferably 92.5 to 95.0 wt.-%.

The first heterophasic propylene copolymer (A) preferably is a virgin polymer.

Heterophasic propylene copolymers suitable as first heterophasic propylene copolymer (A) are commercially available.

Before blending with the other components for preparing the composition according to the invention the first heterophasic propylene copolymer (A) can be aerated, e.g. as described in EP 3 786 190 A1, for removing volatile components.

### Second Heterophasic Propylene Copolymer (B)

The second heterophasic propylene copolymer (B) comprises a matrix phase and an elastomer phase dispersed therein.

The second heterophasic propylene copolymer (B) has a melt flow rate MFR₂ (230° C., 2.16 kg, ISO 1133) of 3.0 to 30 g/10 min, preferably 4.0 to 20.0 g/10 min, more preferably 4.5 to 10.0 g/10 min.

The second heterophasic propylene copolymer (B) can be characterized by the CRYSTEX QC analysis. In the CRYSTEX QC analysis a crystalline fraction (CF) and a soluble fraction (SF) are obtained which can be quantified and analysed in regard of the monomer and comonomer content as well as the intrinsic viscosity (iV).

The second heterophasic propylene copolymer (B) preferably shows one or all of the following properties in the CRYSTEX QC analysis:
a crystalline fraction (CF) content determined according to CRYSTEX QC analysis in the range from 65.0 to 85.0 wt.-%, preferably from 70.0 to 82.5 wt.-%, more preferably from 74.0 to 80.0 wt.-%; and
a soluble fraction (SF) content determined according to CRYSTEX QC analysis in the range from 15.0 to 35.0 wt.-%, preferably in the range from 17.5 to 30.0 wt.-%, more preferably in the range from 20.0 to 26.0 wt.-%.

Said crystalline fraction (CF) preferably has one or more, preferably all of the following properties:
an ethylene content (C2(CF)), as determined by FT-IR spectroscopy calibrated by quantitative ¹³C-NMR spectroscopy, of 0.1 to 5.0 wt.-%, preferably of 0.2 to 4.0 wt. %, more preferably of 0.5 to 3.0 wt %; and/or
an intrinsic viscosity (iV(CF)), as measured in decalin according to DIN ISO 1628/1 at 135° C., of less than 2.5 dl/g, preferably of 1.2 to 2.4 dl/g, more preferably of 1.6 to 2.2 dl/g.

Said soluble fraction (SF) preferably has one or more, preferably all of the following properties:
an ethylene content (C2(SF)), as determined by FT-TR spectroscopy calibrated by quantitative ¹³C-NMR spectroscopy, in the range from 18.0 to 30.0 wt.-%, preferably from 19.0 to 28.0 wt.-%, more preferably from 20.0 to 26.0 wt.-%; and/or
an intrinsic viscosity (iV(SF)), as measured in decalin according to DIN ISO 1628/1 at 135° C., of 4.10 to 10.00 dl/g, preferably of 4.50 to 8.00 dl/g, more preferably of 5.00 to 6.00 dl/g.

The second heterophasic propylene copolymer (B) preferably comprises units derived from ethylene in an amount of from 2.5 to 12.5 wt.-%, more preferably from 4.0 to 10.0 wt.-%, still more preferably from 5.0 to 7.5 wt.-%.

The ratio of the intrinsic viscosities of the soluble fraction and crystalline fraction (IV(SF)/IV(CF)) is preferably more than 2.0, more preferably of 2.2 to 3.5, still more preferably of 2.5 to 3.2.

The ratio of the ethylene contents of the soluble fraction and crystalline fraction (C2(SF)/C2(CF)) is preferably in the range of from 5.0 to 17.5, more preferably in the range of from 7.5 to 15.0, still more preferably in the range of from 10.0 to 12.5.

The second heterophasic propylene copolymer (B) further preferably has one or more, preferably all, of the following properties:
a melting temperature Tm of from 155 to 175° C., more preferably from 157 to 172° C., still more preferably from 160 to 170° C.; and/or
a crystallization temperature Tc of from 110 to 130° C., more preferably from 112 to 127° C., still more preferably from 114 to 124° C.,
all of said temperatures being determined by differential scanning calorimetry (DSC).

The second heterophasic propylene copolymer (B) preferably shows a good balance of properties in regard of mechanical properties, impact properties and heat stability: The second heterophasic propylene copolymer (B) preferably has a tensile modulus of from 850 to 1300 MPa, more preferably from 900 to 1200 MPa, still more preferably from 1000 to 1150 MPa.

Further the second heterophasic propylene copolymer (B) preferably has a Charpy Notched Impact Strength at 23° C. (CNIS at 23° C.) of from 30 to 75 kJ/m², more preferably from 40 to 60 kJ/m².

It is preferred that the second heterophasic propylene copolymer (B) consists of propylene units and ethylene units only.

Although not measured, the content of units derived from propylene (C3) in the soluble fraction (SF) preferably adds up to 100 wt.-% with the content of units derived from ethylene (C2) in the soluble fraction (SF).

The content of units derived from propylene (C3) in the soluble fraction (SF) is preferably 70.0 to 82.0 wt.-%, more preferably 72.0 to 81.0 wt.-%, still more preferably 74.0 to 80.0 wt.-%.

Although not measured the content of units derived from propylene (C3) in the crystalline fraction (CF) preferably adds up to 100 wt.-% with the content of units derived from ethylene (C2) in the crystalline fraction (CF).

The content of units derived from propylene (C3) in the crystalline fraction (CF) is preferably 95.0 to 99.9 wt.-%, more preferably 96.0 to 99.8 wt.-%, still more preferably 97.0 to 99.5 wt.-%.

The total content of units derived from propylene (C3) in the second heterophasic propylene copolymer (B) is preferably 87.5 to 97.5 wt.-%, more preferably 90.0 to 96.0 wt.-%, still more preferably 92.5 to 95.0 wt.-%.

The second heterophasic propylene copolymer (B) preferably is a virgin polymer.

Heterophasic propylene copolymers suitable as second heterophasic propylene copolymer (B) are commercially available.

Before blending with the other components for preparing the composition according to the invention the second heterophasic propylene copolymer (B) can be aerated, e.g. as described in EP 3 786 190 A1, for removing volatile components.

### Mixed-Plastics Polypropylene Blend (C)

The mixed-plastics polypropylene blend (C) is a polypropylene rich recycled material, meaning that it comprises significantly more polypropylene than polyethylene. Recycled waste streams, which are high in polypropylene can be obtained for example from the automobile industry, particularly as some automobile parts such as bumpers are sources of fairly pure polypropylene material in a recycling stream.

Preferably, the polypropylene rich recycled material is obtained from recycled waste by means of plastic recycling processes known in the art. Such recyclates are commercially available, e.g. from Corepla (Italian Consortium for the collection, recovery, recycling of packaging plastic wastes), Resource Plastics Corp. (Brampton, ON), Kruschitz GmbH, Plastics and Recycling (AT), Vogt Plastik GmbH (DE), Mtm Plastics GmbH (DE) etc. Non-exhaustive examples of polypropylene rich recycled materials include: Dipolen®PP (Mtm Plastics GmbH), Axpoly® recycled polypropylene pellets (Axion Ltd) and PolyPropylene Copolymer (BSP Compounds).

During recycling, any reasonable measure will usually be taken for any components other than polyethylene and polypropylene to be reduced/removed as far as the final application or use suggests such measures; however, other components are often present in small amounts.

Other such components include polystyrene (PS), polyamides (PA), polyethylene terephthalate (PET), which are all present in as low an amount as possible, preferably below the detection limit.

The mixed-plastics polypropylene blend (C) preferably has a melt flow MFR₂, determined according to ISO 1133 at 230° C. and 2.16 kg, in the range from 10.0 to 40.0 g/10 min, more preferably in the range from 12.0 to 35.0 g/10 min, most preferably in the range from 13.0 to 30.0 g/10 min.

The mixed-plastics polypropylene blend (C) can be characterized by the CRYSTEX QC analysis. In the CRYSTEX QC analysis a crystalline fraction (CF) and a soluble fraction (SF) are obtained which can be quantified and analysed in regard of the monomer and comonomer content as well as the intrinsic viscosity (iV).

The mixed-plastics polypropylene blend (C) preferably shows one or all of the following properties in the CRYSTEX QC analysis:
a crystalline fraction (CF) content determined according to CRYSTEX QC analysis in the range from 85.0 to 96.0 wt.-%, preferably from 86.5 to 95.5 wt.-%, more preferably from 89.0 to 95.0 wt.-%; and
a soluble fraction (SF) content determined according to CRYSTEX QC analysis in the range from 4.0 to 15.0 wt.-%, preferably from 4.5 to 13.5 wt.-%, more preferably from 5.0 to 11.0 wt.-%.

Said crystalline fraction (CF) preferably has one or more, preferably all of the following properties:
an ethylene content (C2(CF)), as determined by FT-IR spectroscopy calibrated by quantitative ¹³C-NMR spectroscopy, of 1.0 to 10.0 wt.-%, preferably in the range of 1.5 to 9.5 wt.-%, more preferably of 2.0 to 7.5 wt %; and/or
an intrinsic viscosity (iV(CF)), as measured in decalin according to DIN ISO 1628/1 at 135° C., of less than 2.5 dl/g, preferably of 1.1 to 2.3 dl/g, more preferably of 1.4 to 2.0 dl/g.

Said soluble fraction (SF) preferably has one or more, preferably all of the following properties:
an ethylene content (C2(SF)), as determined by FT-IR spectroscopy calibrated by quantitative ¹³C-NMR spectroscopy, in the range from 20.0 to 55.0 wt.-%, preferably from 22.0 to 50.0 wt.-%, more preferably from 24.0 to 48.0 wt.-%; and/or
an intrinsic viscosity (iV(SF)), as measured in decalin according to DIN ISO 1628/1 at 135° C., of 0.9 to 2.1 dl/g, preferably in the range of 1.0 to 2.0 dl/g, more preferably in the range of 1.1 to 1.9 dl/g.

The mixed-plastics polypropylene blend (C) preferably comprises units derived from ethylene in an amount of from 2.5 to 10.0 wt.-%, more preferably from 3.0 to 9.0 wt.-%, still more preferably from 3.5 to 8.0 wt.-%.

The mixed-plastics polypropylene blend (C) preferably has an inorganic residue content, as determined by calcination analysis according to DIN ISO 1172:1996, of 0.05 to 3.0 wt.-%, more preferably in the range from 0.5 to 2.5 wt.-%, most preferably in the range from 1.0 to 2.5 wt.-% The mixed-plastics polypropylene blend (C) preferably originates from post-industrial waste or post-consumer waste, most preferably from post-consumer waste.

The mixed-plastics polypropylene blend (C) preferably has a limonene content, determined by solid phase microextraction (HS-SPME-GC-MS), in the range from 1 to 250 mg/m³.

The presence of limonene is indicative that the mixed-plastics polypropylene blend (C) originates from post-consumer waste.

Further indications of the recycled-nature of the mixed-plastics polypropylene blend (C) include the presence of other polymers, such as polystyrene and polyamide-6, and the presence of fatty acids.

Accordingly, it is further preferred that the mixed-plastics polypropylene blend (C) comprises one or more of polystyrene, polyamide-6 and fatty acids, preferably comprises each of polystyrene, polyamide-6 and fatty acids.

The mixed-plastics polypropylene blend (C) preferably has a CIELAB colour space (L*a*b) of
i) L* of from 50.0 to 97.0, more preferably from 80.0 to 97.0;
ii) a* of from −5.0 to 0.0;
iii) b* of from 0.0 up to, but not including, 22.0.

For producing polypropylene compositions having a light colour, e.g. light grey, it is especially preferred that the L* value is in the range from 80.0 to 97.0.

The mixed-plastics polypropylene blend (C) preferably has a tensile modulus of from 1200 to 1600 MPa, more preferably from 1250 to 1550 MPa, still more preferably from 1300 to 1500 MPa.

Further the mixed-plastics polypropylene blend (C) preferably has a Charpy Notched Impact Strength at 23° C. (CNIS at 23° C.) of from 1.0 to 7.5 kJ/m², more preferably from 2.5 to 6.0 kJ/m² Before blending with the other components for preparing the composition according to the invention the mixed-plastics polypropylene blend (C) can be aerated, e.g. as described in EP 3 786 190 A1, for removing volatile components.

### Mixed-Plastics Polyethylene Blend (D)

The mixed-plastics polyethylene blend (D) is a polyethylene rich recycled material, meaning that it comprises significantly more polyethylene than polypropylene.

Recycled waste streams, which are high in polyethylene can be obtained for example from the post-consumer waste and/or post-industrial waste.

Mixed plastics polyethylene blends preferably are obtained from sorting processes for sorting post-consumer waste and/or post-industrial waste.

Sorting processes suitable for providing the mixed-plastics polyethylene blend (D) are known in the art. Exemplary sorting processes are e.g. described in Dr. Frank Welle, Develop a food grade HDPE recycling process, The Waste & Resources Action Programme, 4 Jun. 2005 (received from https://www.researchgate.net/profile/Frank-Welle-2/publication/284158562_Develop_a_food_grade_HDPE_recycling_process/links/5 64ca7df08ae7ac727e20707/Develop-a-food-grade-HDPE-recycling-process.pdf?origin=publication_detail) or PCT/EP2022/064702.

The mixed-plastics polyethylene blend (D) preferably consists of a natural blend or white blend or a mix of natural and white blends. Natural blends are mixed-plastics polyethylene blends without filler or pigment, whereas white blends are mixed-plastics polyethylene blends with white filler or pigment. The white filler or pigment usually originates from titanium dioxide.

It is preferred that the mixed-plastics polyethylene blend (D) does not include a coloured or black mixed-plastics polyethylene blend.

During recycling, any reasonable measure will usually be taken for any components other than polyethylene and polypropylene to be reduced/removed as far as the final application or use suggests such measures; however, other components are often present in small amounts.

Other such components include polystyrene (PS), polyamides (PA), polyethylene terephthalate (PET), which are all present in as low an amount as possible, preferably below the detection limit.

The mixed-plastics polyethylene blend (D) preferably has a melt flow MFR₂, determined according to ISO 1133 at 190° C. and 2.16 kg, in the range from 0.1 to 5.0 g/10 min, more preferably from 0.2 to 2.5 g/10 min.

Further, the mixed-plastics polyethylene blend (D) preferably has a density of from 970 to 990 kg/m³, preferably from 975 to 985 kg/m³.

White blends thereby tend to have higher densities than natural blends due to the presence of white pigment, such as titanium dioxide.

The high density of the mixed-plastics polyethylene blend (D) indicates that the mixed-plastics polyethylene blend (D) usually includes high amounts of high density polyethylene (HDPE).

The mixed-plastics polyethylene blend (D) preferably comprises units derived from ethylene in an amount of from 90.0 to 99.9 wt.-%, more preferably from 92.5 to 99.9 wt.-%, still more preferably from 95.0 to 99.9 wt.-%, based on the total weight of the mixed-plastics polyethylene blend (D).

Further, the mixed-plastics polyethylene blend (D) preferably comprises units derived from propylene in an amount of from 0.01 to 5.0 wt.-%, more preferably from 0.05 to 2.5 wt.-%, still more preferably from 0.1 to 1.0 wt.-%, based on the total weight of the mixed-plastics polyethylene blend (D).

The mixed-plastics polyethylene blend (D) preferably has an inorganic residue content, as determined by calcination analysis according to DIN ISO 1172:1996, of 0.1 to 5.0 wt.-%, more preferably in the range from 0.2 to 4.0 wt.-%, most preferably in the range from 0.5 to 3.0 wt.-%

The mixed-plastics polyethylene blend (D) preferably has a limonene content, determined by solid phase microextraction (HS-SPME-GC-MS), in the range from 1 to 50 mg/m³.

The presence of limonene is indicative that the mixed-plastics polyethylene blend (D) originates from post-consumer waste.

The mixed-plastics polyethylene blend (D) preferably has a CIELAB colour space (L*a*b) of
i) L* of from 35.0 to 80.0, more preferably from 40.0 to 80.0;
ii) a* of from −5.0 to 0.0;
iii) b* of from −5.0 to 0.0.

The mixed-plastics polyethylene blend (D) preferably has a tensile modulus of from 750 to 1200 MPa, more preferably from 850 to 1100 MPa, still more preferably from 900 to 1000 MPa.

Further the mixed-plastics polyethylene blend (D) preferably has a Charpy Notched Impact Strength at 23° C. (CNIS at 23° C.) of from 10 to 35 kJ/m², more preferably from 15 to 30 kJ/m².

Before blending with the other components for preparing the composition according to the invention the mixed-plastics polyethylene blend (D) can be aerated, e.g. as described in EP 3 786 190 A1, for removing volatile components.

### Ethylene-Based Plastomer (D)

The ethylene-based plastomer (D) is preferably copolymer of ethylene with comonomer units selected from alpha-olefins having from 3 to 12 carbon atoms, preferably from alpha-olefins having from 4 to 10 carbon atoms, more preferably from 1-butene or 1-octene, most preferably from 1-octene.

Ethylene-based plastomers are usually added for further improving the impact properties of the composition.

The ethylene-based plastomer (D) preferably has one or more, preferably all, of the following properties:
a melt flow rate MFR₂ (190° C., 2.16 kg, ISO 1133) of 0.2 to 2.5 g/10 min, preferably 0.3 to 2.0 g/10 min; and
a density of 850 to 870 kg/m³, preferably from 855 to 865 kg/m³.

The ethylene-based plastomer (D) preferably is a virgin polymer.

Such ethylene-based plastomer are commercially available under the tradename Engage, Exact, Queo, Tafmer or others.

### Inorganic Filler (E)

It is preferred that the inorganic filler (E) is selected from the group containing talc, calcium carbonate, barium sulfate, mica, and mixtures thereof.

Most preferably, the inorganic filler (E) is talc.

The inorganic filler, preferably talc, (E) preferably has a median particle size d₅₀ before compounding of 0.3 to 30.0 micrometers, more preferably 0.5 to 15.0 micrometers.

Further, the inorganic filler, preferably talc, (E) preferably has a top-cut particle size d₉₅ before compounding of 1.0 to 50.0 micrometers, preferably 1.5 to 35.0 micrometers.

The particle size is usually measured by Sedigraph measurement and is given in the technical data sheets of commercial grades.

Such inorganic fillers are commercially available.

### Pigment Masterbatch

The composition of the invention is preferably a pigmented composition.

As such, a pigment masterbatch is provided in an amount in the range from 0.5 to 10.0 wt.-%, more preferably in the range from 2.0 to 10.0 wt.-%, most preferably in the range from 4.0 to 10.0 wt.-%, based on the total weight of the composition.

The pigment masterbatch preferably has a total pigment content in the range from 40.0 to 80.0 wt.-%, based on the total weight of the pigment masterbatch. The pigment masterbatch may comprise one pigment, or it may comprise multiple pigments. When the pigment masterbatch comprises more than one pigment, the pigment masterbatch may be provided as multiple pigment masterbatches, each containing a single pigment, wherein the sum of the amounts of the individual pigment masterbatches equals the total weight of the pigment masterbatch according to the present invention.

The selection of the pigment depends on the intended colour of the composition. Beyond such considerations, the choice of suitable pigment is not restricted. The person skilled in the art would be able to select suitable pigment(s) to achieve a certain end colour of the composition.

### Additives

The further additives are preferably provided in an amount in the range of up to 3.0 wt.-%, preferably in an amount of from 0.1 to 3.0 wt %, still more preferably in an amount of from 0.5 to 2.5 wt %, based on the total weight of the composition. The skilled practitioner would be able to select suitable additives that are well known in the art.

The additives are preferably selected from antioxidants, UV-stabilisers, anti-scratch agents, mould release agents, acid scavengers, lubricants, anti-static agents, and mixtures thereof.

It is understood that the content of additives, given with respect to the total weight of the composition, includes any carrier polymers used to introduce the additives to said composition, i.e. masterbatch carrier polymers. An example of such a carrier polymer would be a polypropylene homopolymer in the form of powder.

### Article

In another aspect, the present invention relates to an article comprising the composition as described above or below in an amount of from 90 to 100 wt.-%, preferably from 95 to 100 wt.-%, more preferably from 98 to 100 wt.-%, still more preferably from 99 to 100 wt.-%.

The article preferably is a moulded article, more preferably a moulded automotive article.

The article is preferably used on the interior of vehicles, such as dashboards, step assists, interior trims, ashtrays, interior body panels and gear shift levers.

The articles prepared from the composition according to the invention show good scratch resistance measured as scratch resistance and MAR resistance and shrinkage behavior measured as isotropic shrinkage, shrinkage in flow and shrinkage cross flow in addition to the above described superior balance of properties of the composition.

It is preferred that the article has a scratch resistance at 10 N in the range from 0.00 to 1.40, more preferably from 0.10 to 1.25.

Further the article preferably has a MAR resistance in one direction at 9 N in the range from 0.00 to 1.40, more preferably from 0.25 to 1.25.

Still further, the article preferably has an isotropic area shrinkage of from 0.25 to 1.25%, more preferably from 0.50 to 1.10%.

Additionally, the article preferably has a shrinkage in flow of from 0.25 to 1.15%, more preferably from 0.50 to 1.00%.

Furthermore, the article preferably has a shrinkage cross flow of from 0.35 to 1.35%, more preferably from 0.60 to 1.20%.

### Use

In yet another aspect the present invention relates to the use of the composition as described above or below for injection moulding of articles, preferably automotive articles, more preferably automotive interior articles.

### Experimental Section

The following Examples are included to demonstrate certain aspects and embodiments of the invention as described in the claims. It should be appreciated by those of skill in the art, however, that the following description is illustrative only and should not be taken in any way as a restriction of the invention.

### Test Methods

### a) CRYSTEX

Determination of Crystalline and Soluble Fractions and their Respective Properties (IV and Ethylene Content)

The crystalline (CF) and soluble fractions (SF) of the polypropylene (PP) compositions as well as the comonomer content and intrinsic viscosities of the respective fractions were analysed by use of the CRYSTEX instrument, Polymer Char (Valencia, Spain). Details of the technique and the method can be found in literature (Ljiljana Jeremic, Andreas Albrecht, Martina Sandholzer & Markus Gahleitner (2020) Rapid characterization of high-impact ethylene-propylene copolymer composition by crystallization extraction separation: comparability to standard separation methods, International Journal of Polymer Analysis and Characterization, 25:8, 581-596)

The crystalline and amorphous fractions are separated through temperature cycles of dissolution at 160° C., crystallization at 40° C. and re-dissolution in 1,2,4-trichlorobenzene at 160° C. Quantification of SF and CF and determination of ethylene content (C2) are achieved by means of an integrated infrared detector (IR4) and for the determination of the intrinsic viscosity (iV) an online 2-capillary viscometer is used.

The IR4 detector is a multiple wavelength detector measuring IR absorbance at two different bands (CH₃ stretching vibration (centred at app. 2960 cm⁻¹) and the CH stretching vibration (2700-3000 cm⁻¹) that are serving for the determination of the concentration and the Ethylene content in Ethylene-Propylene copolymers. The IR4 detector is calibrated with series of 8 EP copolymers with known Ethylene content in the range of 2 wt.-% to 69 wt.-% (determined by ¹³C-NMR) and each at various concentrations, in the range of 2 and 13 mg/ml. To encounter for both features, concentration and ethylene content at the same time for various polymer concentrations expected during Crystex analyses the following calibration equations were applied:

$$Conc = a + b ⋆ Abs ( CH ) + c ⋆ {( Abs ( CH ) )}^{2} + d ⋆ Abs ( {CH}_{3} ) + e ⋆ ( {Abs ( {CH}_{3} )}^{2} + f ⋆ ( Abs ( CH ) ⋆ Abs ( {CH}_{3} ) \qquad ( Equation 1 )$$

$${CH}_{3} / 1000 C = a + b ⋆ Abs ( CH ) + c ⋆ Abs ( {CH}_{3} ) + d ⋆ ( Abs ( {CH}_{3} ) / Abs ( CH ) ) + e ⋆ {( Abs ( {CH}_{3} ) / Abs ( CH ) )}^{2} \qquad ( Equation 2 )$$

The constants a to e for equation 1 and a to f for equation 2 were determined by using least square regression analysis.

The CH₃/1000 C is converted to the ethylene content in wt.-% using following relationship:

$$wt . - \% ( Ethylene in EP Copolymers ) = 100 - {CH}_{3} / 1000 TC ⋆ 0.3 \qquad ( Equation 3 )$$

Amounts of Soluble Fraction (SF) and Crystalline Fraction (CF) are correlated through the XS calibration to the “Xylene Cold Soluble” (XCS) quantity and respectively Xylene Cold Insoluble (XCI) fractions, determined according to standard gravimetric method as per ISO16152. XS calibration is achieved by testing various EP copolymers with XS content in the range 2-31 wt.-%. The determined XS calibration is linear:

$$wt . - \% XS = 1.01 ⋆ wt \% SF \qquad ( Equation 4 )$$

Intrinsic viscosity (iV) of the parent EP copolymer and its soluble and crystalline fractions are determined with a use of an online 2-capillary viscometer and are correlated to corresponding iV's determined by standard method in decalin according to ISO 1628-3. Calibration is achieved with various EP PP copolymers with iV=2-4 dL/g. The determined calibration curve is linear:

$$iV ( dL / g ) = a ⋆ Vsp / c \qquad ( equation 5 )$$

The samples to be analysed are weighed out in concentrations of 10 mg/ml to 20 mg/ml. To avoid injecting possible gels and/or polymers which do not dissolve in TCB at 160° C., like PET and PA, the weighed out sample was packed into a stainless steel mesh MW 0.077/D 0.05mmm.

After automated filling of the vial with 1,2,4-TCB containing 250 mg/l 2,6-tert-butyl-4-methylphenol (BHT) as antioxidant, the sample is dissolved at 160° C. until complete dissolution is achieved, usually for 60 min, with constant stirring of 400 rpm. To avoid sample degradation, the polymer solution is blanketed with the N2 atmosphere during dissolution.

A defined volume of the sample solution is injected into the column filled with inert support where the crystallization of the sample and separation of the soluble fraction from the crystalline part is taking place. This process is repeated two times. During the first injection the whole sample is measured at high temperature, determining the iV [dl/g] and the C2 [wt.-%] of the PP composition. During the second injection the soluble fraction (at low temperature) and the crystalline fraction (at high temperature) with the crystallization cycle are measured (wt.-% SF, wt.-% C2, iV).

### b) Xylene Cold Soluble Fraction (XCS, Wt %)

Xylene cold soluble fraction (XCS) was determined at 25° C. according ISO 16152; first edition; 2005-07-01. The part which remains insoluble is the xylene cold insoluble (XCI) fraction.

### c) Intrinsic Viscosity

Intrinsic viscosity was measured according to DIN ISO 1628/1, October 1999 (in Decalin at 135° C.).

### d) Charpy Notched Impact Strength

was determined according to ISO 179-1 eA at +23° C. and at −20° C. on injection moulded specimens of 80×10×4 mm³ prepared according to EN ISO 1873-2. The measurement was done after 96 h conditioning time at 23° C. of the specimen.

### e) Tensile Modulus, Tensile Stress at Yield and Elongation at Break

were measured according to ISO 527-2 (cross head speed=1 mm/min; test speed 50 mm/min at 23° C.) using injection moulded specimens 1B prepared as described in EN ISO 1873-2 (dog bone shape, 4 mm thickness). The measurement was done after 96 h conditioning time at 23° C. of the specimen.

### f) Flexural Modulus

The flexural modulus was determined according to ISO 178 at a test speed of 2 mm/min and a force of 100 N, whereby the length of the span between the supports was 64 mm, on test specimens having a dimension of 80×10×4 mm³ (length×width×thickness) prepared by injection moulding according to EN ISO 1873-2.

### g) Comonomer Content

### Poly(Propylene-Co-Ethylene)—Ethylene Content—IR Spectroscopy

Quantitative infrared (IR) spectroscopy was used to quantify the ethylene content of the poly(ethylene-co-propene) copolymers through calibration to a primary method. Calibration was facilitated through the use of a set of in-house non-commercial calibration standards of known ethylene contents determined by quantitative ¹³C solution-state nuclear magnetic resonance (NMR) spectroscopy. The calibration procedure was undertaken in the conventional manner well documented in the literature. The calibration set consisted of 38 calibration standards with ethylene contents ranging 0.2-75.0 wt. % produced at either pilot or full scale under a variety of conditions. The calibration set was selected to reflect the typical variety of copolymers encountered by the final quantitative IR spectroscopy method. Quantitative IR spectra were recorded in the solid-state using a Bruker Vertex 70 FTIR spectrometer. Spectra were recorded on 25×25 mm square films of 300 μm thickness prepared by compression moulding at 180-210° C. and 4-6 MPa. For samples with very high ethylene contents (>50 mol %) 100 μm thick films were used. Standard transmission FTIR spectroscopy was employed using a spectral range of 5000-500 cm⁻¹, an aperture of 6 mm, a spectral resolution of 2 cm⁻¹, 16 background scans, 16 spectrum scans, an interferogram zero filling factor of 64 and Blackmann-Harris 3-term apodisation. Quantitative analysis was undertaken using the total area of the CH₂ rocking deformations at 730 and 720 cm⁻¹ (AQ) corresponding to (CH₂)_{>2} structural units (integration method G, limits 762 and 694 cm⁻¹). The quantitative band was normalised to the area of the CH band at 4323 cm⁻¹ (A_{R}) corresponding to CH structural units (integration method G, limits 4650, 4007 cm⁻¹). The ethylene content in units of weight percent was then predicted from the normalised absorption (A_{Q}/A_{R}) using a quadratic calibration curve. The calibration curve having previously been constructed by ordinary least squares (OLS) regression of the normalised absorptions and primary comonomer contents measured on the calibration set.

### Poly(Propylene-Co-Ethylene)—Ethylene Content—¹³C NMR Spectroscopy

Quantitative ¹³C{¹H} NMR spectra were recorded in the solution-state using a Bruker Avance III 400 NMR spectrometer operating at 400.15 and 100.62 MHz for ¹H and ¹³C respectively. All spectra were recorded using a ¹³C optimised 10 mm extended temperature probehead at 125° C. using nitrogen gas for all pneumatics. Approximately 200 mg of material was dissolved in 3 ml of 1,2-tetrachloroethane-d₂ (TCE-d₂) along with chromium (III) acetylacetonate (Cr(acac)₃) resulting in a 65 mM solution of relaxation agent in solvent (Singh, G., Kothari, A., Gupta, V., Polymer Testing 28 5 (2009), 475).

To ensure a homogenous solution, after initial sample preparation in a heat block, the NMR tube was further heated in a rotatory oven for at least 1 hour. Upon insertion into the magnet the tube was spun at 10 Hz. This setup was chosen primarily for the high resolution and quantitatively needed for accurate ethylene content quantification. Standard single-pulse excitation was employed without NOE, using an optimised tip angle, 1 s recycle delay and a bi-level WALTZ16 decoupling scheme (Zhou, Z., et al. J. Mag. Reson. 187 (2007) 225, and in Busico, V., et al, Macromol. Rapid Commun. 2007, 28, 1128). A total of 6144 (6k) transients were acquired per spectra. Quantitative ¹³C{¹H} NMR spectra were processed, integrated and relevant quantitative properties determined from the integrals. All chemical shifts were indirectly referenced to the central methylene group of the ethylene block (EEE) at 30.00 ppm using the chemical shift of the solvent. This approach allowed comparable referencing even when this structural unit was not present. Characteristic signals corresponding to the incorporation of ethylene were observed (Cheng, H. N., Macromolecules 17 (1984), 1950) and the comonomer fraction calculated as the fraction of ethylene in the polymer with respect to all monomer in the polymer: fE=(E/(P+E) The comonomer fraction was quantified using the method of Wang et. al. (Wang, W-J., Zhu, S., Macromolecules 33 (2000), 1157) through integration of multiple signals across the whole spectral region in the ¹³C{¹H} spectra. This method was chosen for its robust nature and ability to account for the presence of regio-defects when needed. Integral regions were slightly adjusted to increase applicability across the whole range of encountered comonomer contents. For systems with very low ethylene content where only isolated ethylene in PPEPP sequences were observed the method of Wang et. al. was modified reducing the influence of integration of sites that are no longer present. This approach reduced the overestimation of ethylene content for such systems and was achieved by reduction of the number of sites used to determine the absolute ethylene content to E=0.5(Sββ+Sβγ+Sβδ+0.5(Sαβ+Sαγ)) Through the use of this set of sites the corresponding integral equation becomes E=0.5(I_{H}−I_{G}+0.5(I_{C}+I_{D})) using the same notation used in the article of Wang et. al. (Wang, W-J., Zhu, S., Macromolecules 33 (2000), 1157). Equations used for absolute propylene content were not modified. The mole percent comonomer incorporation was calculated from the mole fraction: E [mol %]=100*fE. The weight percent comonomer incorporation was calculated from the mole fraction: E [wt. %]=100*(fE*28.06)/((fE*28.06)+((1−fE)*42.08)).

### h) Comonomer Content

Contents were determined using a film thickness method using the intensity of the quantitative band I(q) and the thickness of the pressed film T using the following relationship: [I(q)/T]m+c=C where m and c are the coefficients determined from the calibration curve constructed using the comonomer contents obtained from ¹³C-NMR spectroscopy.

Comonomer content was measured in a known manner based on Fourier transform infrared spectroscopy (FTIR) calibrated with ¹³C-NMR, using Nicolet Magna 550 IR spectrometer together with Nicolet Omnic FTIR software. Films having a thickness of about 250 μm were compression moulded from the samples. Similar films were made from calibration samples having a known content of the comonomer. The comonomer content was determined from the spectrum from the wave number range of from 1430 to 1100 cm⁻¹. The absorbance was measured as the height of the peak by selecting the so-called short or long base line or both. The short base line was drawn in about 1410-1320 cm⁻¹ through the minimum points and the long base line about between 1410 and 1220 cm⁻¹. Calibrations needed to be done specifically for each base line type. Also, the comonomer content of the unknown sample was within the range of the comonomer contents of the calibration samples.

### i) MFR

Melt flow rates were measured with a load of 2.16 kg (MFR₂) at 230° C. (polypropylene based materials) or at 190° C. (polyethylene based materials). The melt flow rate is that quantity of polymer in grams which the test apparatus standardized to ISO 1133 extrudes within 10 minutes at a temperature of 230° C. (or 190° C.) under a load of 2.16 kg.

### j) Density

Density was measured according to ISO 1183-187. Sample preparation was done by compression moulding in accordance with ISO 1872-2:2007.

k) DSC Analysis, Melting Temperature (Tₘ) and Heat of Fusion (H_{f}), Crystallization Temperature (T_{c}) and Heat of Crystallization (H_{c})

were measured with a TA Instrument Q200 differential scanning calorimetry (DSC) on 5 to 7 mg samples. DSC is run according to ISO 11357/part 3/method C2 in a heat/cool/heat cycle with a scan rate of 10° C./min in the temperature range of −30 to +225° C. Crystallization temperature (T,) and crystallization enthalpy (He) are determined from the cooling step, while melting temperature (Tₘ) and melting enthalpy (Hm) are determined from the second heating step.

### l) Scratch Resistance

To determine the scratch visibility, a Cross Hatch Cutter Model 420P, manufactured by Erichsen, was used. For the tests, plaques of 70×70×4 mm size were cut from a moulded grained plaque of size 140×200×4 mm (grain parameters: average grain size=1 mm, grain depth=0.12 mm, conicity=6°). The period between injection moulding of specimens and scratch-testing was 7 days. For testing, the specimens must be clamped in a suitable apparatus as described above. Scratches were applied at a force of 10 N using a cylindrical metal pen with a ball shaped end (radius=0.5 mm+0.01). A cutting speed of 1000 mm/min was used. A minimum of 20 scratches parallel to each other were brought up at a load of 10 N with a distance of 2 mm. The application of the scratches was repeated perpendicular to each other, so that the result was a scratching screen. The scratching direction should be unidirectional.

The scratch visibility is reported as the difference of the luminance, AL, of the unscratched and the scratched areas. AL values were measured using a spectrophotometer that fulfils the requirements to DIN 5033. A detailed test description of the test method (Erichsen cross hatch cutter method) can be found in the article “Evaluation of scratch resistance in multiphase PP blends” by Thomas Koch and Doris Machl, published in Polymer Testing, 26 (2007), p. 927-936.

### m) MAR Resistance

The MAR resistance refers to resistance with which a grained component surface without finish treatment opposes the mechanical action exerted by a disk that is rounded at the edge. A machine guided metal disk creates parallel lines with a spacing of 0.5 mm on a grained, unfinished plastic surface using the rounded edge of a reference disk. The reference disk is clamped at a right angle to the push/pull direction perpendicular to the specimen. The evaluation of the MAR results in the gloss change between stressed and unstressed surface. The tests was performed with a load of 9 N in one direction on 70×70×3 mm plaques cut out of 148×210×3 mm injection moulded plates. The load was applied by using a RPG2 device. The gloss was measured by Datacolour measurement device.

### n) Isotropic Area Shrinkage

The area shrinkage was calculated from shrinkage data determined on circular sector plates of 320 mm radius, 20° opening angle and 2.8 mm thickness produced by injection moulding with an Engel ES 1350/350 machine and filled through a rectangular gate of 7.6×2.8 mm² at the base of the sector. A melt temperature of 240° C., a mould temperature of 25° C. and a filling time of 3.5 s were used, followed by a holding time of 20 s at a holding pressure of 400 bar.

Instead of measuring the external dimension of the plates, a pattern of circular dots was generated on the plates by eroded spots of 1 mm diameter at distances between 5 and 10 mm. The original pattern is recorded immediately after de-moulding by an OGP Smartscope Flash 400 optical gauging system and used as dimensional reference. After 96 h at 23° C., the post-shrinkage moulding pattern is determined and all deviations of point-to-point distances are recorded. For calculating the isotropic area shrinkage, a number of measuring points is connected by vectors and the resulting area determined, with A being the area after 96 h and A₀ the area before that period. The isotropic area shrinkage, Sᵢₛₒ, is then calculated as

$${S}_{i s o} = 1 - \sqrt{\frac{\sum A}{\sum {A}_{0}}}$$

### o) Shrinkage in Flow and Shrinkage Cross Flow

Shrinkage in flow and shrinkage cross flow were determined on film gate injection moulded articles. One is a circular sector (radius 300 mm and opening angle of 20°) and the other one a stripe (340×65 mm). 2.8 mm thick specimen were injection moulded at the same time at a back pressure of 400 bar. The melt temperature is 240° C. and the temperature of the tool 25° C., respectively. Average flow front velocity is 3.5±0.2 mm/s. After the injection moulding process the shrinkage of the specimens is measured at 23° C. and 50% humidity. The measurement was done 96 hours after the injection moulding.

### p) Fogging

Fogging was measured according to ISO 75201:2011-11, method B (gravimetric method) on compression-moulded specimens (diameter 80 mm+/−1 mm, thickness 2 mm) cut out from an injection moulded plate. With this method, the mass of fogging condensate on aluminium foil in mg by means weighing of foil before and after the fogging test is determined. The term “fogging” refers to a fraction of volatile substances condensed on glass parts as e.g. the windscreen of a vehicle.

### q) Screening of Organic Emissions by Thermo-Desorption Analysis

This method describes the semi-quantitative determination of organic compounds emitting from polyolefins. It is similar to the VDA 278 (October 2011) but includes specific adjustments.

Directly after the production the sample (injection moulded plaque, DIN-A5) is sealed in an aluminium-coated polyethylene bag and provided to the lab within 14 days. In the lab, it is stored openly for 7 days below 25° C. After this period, an aliquot of 60±5 mg is prepared from the stored sample. Trimming the aliquot should aim for a maximum coherent area. It is not the aim to create the largest possible surface area by cutting the aliquot into smaller pieces. The diameter of the sample injection tube should be used first. Length and thickness should be chosen accordingly, considering the specified aliquot weight. The aliquot is directly desorbed using heat and a flow of helium gas. Volatile and semi-volatile organic compounds are extracted into the gas stream and cryo-focused prior to the injection into a gas chromatographic (GC) system for analysis. The method comprises two extraction stages: In the analysis of low-boiling substances (LBS) the aliquot is desorbed at 90° C. for 30 min to determine volatile organic compounds in the boiling/elution range up to n-C25 (n-pentacosane). The analysis of high-boiling substances (HBS) involves a further desorption step of the same aliquot at 120° C. for 60 min to determine semi-volatile compounds in the boiling/elution range from n-C14 (n-tetradecane) to n-C32 (n-dotriacontane).

Similar to the VOC and FOG value in the VDA 278, the LBS is calculated as toluene equivalent (TE) and the HBS is calculated as hexadecane equivalent (HE) applying a semi-quantitation and a respective calibration. The result is expressed in “μg/g”. Integration parameters for the LBS and HBS evaluation are chosen in such way that the “area reject” corresponds to the area of 1 μg/g (TE and HE, respectively). Thus, smaller peaks do not add to the semi-quantitative result. The GC oven program is kept the same, no matter if a calibration run, an LBS run or an HBS run was performed. It starts at 50° C. (1 min hold), followed by a ramp of 10° C./min and an end temperature of 320° C. (10 min hold). For the GC column an Agilent DB5: 50 μm×250 μm×0.25 μm (or comparable) is used. The method requires a Thermal Desorption System TDS 3 (Gerstel) and a Cooled Injection System CIS 4 (Gerstel) as well as a GC system with a flame ionisation detector (FID) but does not involve a mass spectrometer. Instead of 280° C. the CIS end temperature is always set to 380° C.

### r) CIELAB Color Space (L*a*b*)

In the CIE L*a*b* uniform color space, the color coordinates are: L*—the lightness coordinate; a*—the red/green coordinate, with +a* indicating red, and −a* indicating green; and b*—the yellow/blue coordinate, with +b* indicating yellow, and −b* indicating blue. The L*, a*, and b*coordinate axis define the three dimensional CIE color space. Standard Konica/Minolta Colorimeter CM-3700A.

s)Inorganic Residues

Inorganic residues are quantified according to DIN ISO 1172:1996 using a Perkin Elmer TGA 8000. Approximately 10-20 mg of material was placed in a platinum pan. The temperature was equilibrated at 50° C. for 10 minutes, and afterwards raised to 950° C. under nitrogen at a heating rate of 20° C./min. The ash content was evaluated as the weight % at 850° C.

### t) Limonene Detection

### Estimation of Limonene

The determination of benzene and limonene is based on a static headspace (HS) approach. This analysis uses a combination of a HS sampler with a gas chromatograph (GC) and a mass spectrometer (MS) for screening purposes. Samples were delivered to the lab in sealed aluminium-coated polyethylene (PE) bags. Prior to the analysis, samples were cryo-milled, a portion of 2.000±0.100 g was weighed in a 20 ml HS vial and tightly closed. For every sample, a double determination was performed.

### HS/GC/MS Parameters

HS parameters (Agilent G1888 Headspace Sampler)
   Vial equilibration time: 120 min (sample), 5 min (standard)
   Oven temperature: 100° C. (sample), 200° C. (standard)
   Loop temperature: 110° C. (sample), 205° C. (standard)
   Transfer line temperature: 120° C. (sample), 210° C. (standard)
   Low shaking
GC parameters (Agilent 7890A GC System)
   Column: ZB-WAX 7HG-G007-22
   (30 μm×250 μm×1 μm)
   Carrier gas: Helium 5.0
   Flow: 2 ml/min
   Split: 5:1
   GC oven program: 35° C. for 0.1 min
      10° C./min until 250° C.
      250° C. for 1 min
MS parameters (Agilent 5975C inert XL MSD)
   Acquisition mode: Scan
   Scan parameters:
      Low mass: 20
      High mass: 200
      Threshold: 10
Software/Data evaluation
   MSD ChemStation E.02.02.1431
   MassHunter GC/MS Acquisition B.07.05.2479
   AMDIS GC/MS Analysis Version 2.71
   NIST/EPA/NIH Mass Spectral Library (2011 version)
   NIST Mass Spectral Search Program Version 2.0 g
AMDIS deconvolution parameters
   Minimum match factor: 80
   Threshold: Low
   Scan direction: High to Low
   Data file format: Agilent files
   Instrument type: Quadrupole
   Component width: 20
   Adjacent peak subtraction: Two
   Resolution: High
   Sensitivity: Very high
   Shape requirements: Medium
   Solvent tailing: 91 m/z
   Column bleed: 207 m/z
   Min. model peaks: 2
   Min. S/N: 10
   Min. certain peaks: 0.5
MSD ChemStation integration parameters
   Integrator: ChemStation
   Initial area reject: 0
   Initial peak width: 0.005
   Shoulder detection: off
   Initial threshold: 10.5

In this study, the statement “below the limit of detection (<LOD)” describes a condition where either the match factor is below 80 (AMDIS) or the signal to noise ratio (Pk−pk S/N=Corrected signal/Pk-pk noise, MSD ChemStation signal to noise report) of the peak in the sample run is below 3. The results refer solely to the measured samples, time of measurement and the applied parameters.

### Standard Solutions

For a positive identification and comparison with the (lowest) odour detection thresholds (ODT), a limonene standard was used.

For the HS/GC/MS analysis, 5 μl of the respective standard was injected in a 20 ml HS vial, tightly closed and measured.

Assuming full vaporisation of the standard substance, the concentration limonene in the HS c_{G} was estimated as listed in the below table.

TABLE
Calibration standard and ODT

| | | c_{G}/mg | Target | (lowest) |
|---|---|---|---|---|
| Analyte | Solvent | m⁻³ | ion (m/z) | ODT/mg m⁻³ [1] |
| Limonene | 2-Butanol | 75 | 68 | 0.21 |

### Data Evaluation

The concentration of an analyte in the HS C_{G} is calculated by considering the substance amount m_{G} and the available HS volume V_{G} (Equation 1).

$${c}_{G}^{S tandard} [ mg / {m}^{3} ] = \frac{{m}_{G}^{S tandard}}{{V}_{G}^{S tandard}} \qquad Equation 1$$

To estimate the concentration of an analyte in the HS above a polymer sample, the response factor, Rf of a one-point calibration is required (Equation 2). By integrating the extracted ion chromatogram (EIC), the peak area is obtained for the analyte. The corresponding target ion is listed in the above table.

$$Rf = \frac{{c}_{G}^{Standard}}{Peak {area}^{Standard}} \qquad Equation 2$$

The concentration of an analyte in the HS above a polymer sample

$${c}_{G}^{Sample}$$

is calculated by multiplying the response factor with the EIC peak area of the sample (Equation 3).

$${c}_{G}^{Sample} [ mg / {m}^{3} ] = Rf * Peak {area}^{Sample} \qquad Equation 3$$

Additionally, the odour relevance of an analyte in the HS above a polymer sample is estimated by the odour activity value (OAV). Therefore, the concentration of an analyte in the HS above a polymer sample

$${c}_{G}^{Sample}$$

is compared with the (lowest) odour detection threshold (ODT) found in literature (Equation 4)[1]. A value above 1 indicates the relevance of an analyte to the odour at the given HS temperature.

$$O A V = \frac{{c}_{G}^{Sample} [ mg / {m}^{3} ]}{ODT [ mg / {m}^{3} ]} \qquad Equation 4$$

### Considerations and Limitations

It must be considered that the ODT for some substances is below the detection limit (LOD) of the method. Therefore, components below the LOD might be missed although still relevant to the overall odour.

The OAV is based on the assumption that the HS parameters are somewhat relatable to the measurement conditions of an ODT determination. Of course, this is not fully applicable because temperature settings of 100° C. are not necessarily chosen for such experiments and have therefore limited practical value. Nevertheless, this approach can at least indicate the odour relevance of the defined marker substances.

Considering all the mentioned assumptions and limitations, the determined concentrations in the HS above the sample and odour activity values must be taken as rough estimates only.

### REFERENCES

[1]Van Gemert L. J., Odour Thresholds: Compilations of odour threshold values in air, water and other media, Utrecht, Oliemans Punter & Partners BV, 2011.

### Experiments

a) Heterophasic propylene copolymers HECO1 and HECO2

### Catalyst Systems:

For the polymerization process of HECO2 a traditional trans-esterified high yield MgCl₂—supported Ziegler-Natta polypropylene catalyst component comprising diethyl phthalate as internal donor was used. The catalyst component and its preparation concept are described in general for example in patent publications EP491566, EP591224 and EP586390.

Accordingly, the catalyst component was prepared as follows: first, 0.1 mol of MgCl₂×3 EtOH was suspended under inert conditions in 250 ml of decane in a reactor at atmospheric pressure. The solution was cooled to −15° C. and the 300 ml of cold TiCl₄ was added while maintaining the temperature at said temperature. Then, the temperature of the slurry was increased slowly to 20° C. At this temperature, 0.02 mol of dioctylphthalate (DOP) was added to the slurry. After the addition of the phthalate, the temperature was raised to 135° C. during 90 minutes and the slurry was allowed to stand for 60 minutes. Then, another 300 ml of TiCl₄ was added and the temperature was kept at 135° C. for 120 minutes. After this, the catalyst was filtered from the liquid and washed six times with 300 ml heptane at 80° C. Then, the solid catalyst component was filtered and dried.

The catalyst was further modified (VCH modification of the catalyst). 35 ml of mineral oil (Paraffinum Liquidum PL68) was added to a 125 ml stainless steel reactor followed by 0.82 g of triethyl aluminum (TEAL) and 0.33 g of dicyclopentyl dimethoxy silane (donor D) under inert conditions at room temperature. After 10 minutes 5.0 g of the catalyst prepared above (Ti content 1.4 wt.-%) was added and after additionally 20 minutes 5.0 g of vinylcyclohexane (VCH) was added. The temperature was increased to 60° C. during 20 minutes and was kept there for 20 hours. Finally, the temperature was decreased to 20° C. and the concentration of unreacted VCH in the oil/catalyst mixture was analysed and was found to be 200 ppm weight

The catalyst used for producing HECO1 was a Ziegler-Natta catalyst commercially available from Lyondell Basell (IT), under the trade name ZN180M.

HECO1 was made in prepolymerization/loop reactor/gas phase reactor 1/gas phase reactor 2 configuration followed by a pelletization step.

HECO2 was made in prepolymerization/loop reactor/gas phase reactor 1/gas phase reactor 2/gas phase reactor 3 configuration followed by a pelletization step.

For HECO1 and HECO2 the catalyst systems defined above were used in combination with triethyl-aluminium (TEAL) as co-catalyst and dicyclopentadienyl-dimethoxy silane (donor D) as external donor.

The polymerization conditions as shown in Table 1.

TABLE 1
Polymerization conditions for the HECOs

| | |
|---|---|
| HECO1 | HECO2 |

Prepolymerization

| | | | |
|---|---|---|---|
| [Co]/[ED] | [mol/mol] | 10 | 6 |
| [Co]/[Ti] | [mol/mol] | 220 | 200 |
| Temperature | [° C.] | 30 | 30 |
| Residence time | [min] | 5 | 0.25 |

Loop reactor

| | | | |
|---|---|---|---|
| Temperature | [° C.] | 75 | 85 |
| Split | [wt.-%] | 52 | 35 |
| H2/C3 | [kg/ton] | 22 | 65 |
| MFR₂ | [g/10 min] | 160 | 140 |

1^{st} Gas phase reactor

| | | | |
|---|---|---|---|
| Temperature | [° C.] | 80 | 85 |
| Split | [wt.-%] | 34 | 40 |
| H2/C3 | [mol/kmol] | 175 | 21 |
| MFR₂ | [g/10 min] | 160 | 55 |
| XCS | [wt.-%] | 2.0 | 1.9 |

2^{nd} Gas phase reactor

| | | | |
|---|---|---|---|
| Temperature | [° C.] | 80 | 85 |
| Split | [wt.-%] | 14 | 15 |
| H2/C3 | [mol/kmol] | 250 | 15 |
| C2/C3 | [mol/kmol] | 550 | 210 |
| MFR₂ | [g/10 min] | 99 | 20 |
| C2 | [wt.-%] | 6.5 | 4.5 |

3^{rd} Gas phase reactor

| | | | |
|---|---|---|---|
| Temperature | [° C.] | — | 85 |
| Split | [wt.-%] | — | 10 |
| H2/C3 | [mol/kmol] | — | 10 |
| C2/C3 | [mol/kmol] | — | 210 |
| C2 | [wt.-%] | — | 7 |

Final Properties (pellet)

| | | | |
|---|---|---|---|
| MFR₂ | [g/10 min] | 100 | 5.5 |
| C2 | [wt.-%] | 6.0 | 6.5 |
| SF (CRYSTEX) | [wt.-%] | 14.5 | 22.4 |
| C2(SF) | [wt.-%] | 32 | 23 |
| iV(SF) | [dL/g] | 1.9 | 5.6 |
| CF (CRYSTEX) | [wt.-%] | 85.5 | 77.6 |
| C2(CF) | [wt.-%] | 2 | 2 |
| iV(CF) | [dL/g] | 1.15 | 1.90 |
| C2(XCS) | [wt.-%] | 54.0 | 22.6 |
| iV(XCS) | [dL/g] | 2.0 | 5.5 |
| Tₘ | [° C.] | 165 | 166 |
| T_{c} | [° C.] | 121 | 115 |
| Tensile modulus | [MPa] | 1400 | 1080 |
| Charpy NIS, 23° C. | [kJ/m²] | 3.2 | 48 |

The heterophasic copolymers HECO1 and HECO2 were compounded in a co-rotating twin-screw extruder Coperion ZSK 47 at 220° C. with 0.15 wt. % antioxidant (frganox B215FF from BASF AG, Germany; this is a 1:2-mixture of Pentaerythrityl-tetrakis(3-(3′,5′-di-tert. butyl-4-hydroxyphenyl)-propionate, CAS-no. 6683-19-8, and Tris (2,4-di-t-butylphenyl) phosphite, CAS-no. 31570-04-4); 0.05 wt.-% of Ca-stearate (CAS-no.1592-23-0, commercially available from Faci, Italy).

The pellets of the heterophasic copolymers HECO1 and HECO2 were aerated before use, to remove volatile organic components as described in EP 3 786 190 A1.

### b) Mixed-Plastics Polypropylene Blend

The properties of the mixed-plastic polypropylene blends PP Blend and of the mixed plastics polyethylene blend PE Blend are given in Table 2.

TABLE 2
Properties of mixed-plastic polypropylene and polyethylene blends

| | | PP Blend | PE Blend |
|---|---|---|---|
| MFR₂ | [g/10 min] | 19 (230° C.) | 0.6 (190° C.) |
| Density | [kg/m³] | 915 | 980 |
| C2(total) | [wt.-%] | 5.3 | 99.7 |
| C3(total) | [wt.-%] | n.m. | 0.3 |
| SF | [wt.-%] | 11.0 | n.m. |
| C2(SF) | [wt.-%] | 26.0 | n.m. |
| iV(SF) | [dL/g] | 1.66 | n.m. |
| CF | [wt.-%] | 89.0 | n.m. |
| C2(CF) | [wt.-%] | 3.0 | n.m. |
| iV(CF) | [dL/g] | 1.61 | n.m. |
| Limonene content | [ppm] | 157 | 2.99 |
| Ash content | [wt.-%] | 0.9-1.5 | 2.3 |
| CIELAB L* | [—] | 87.01 | 41.62 |
| CIELAB a* | [—] | −1.90 | −0.51 |
| CIELAB b* | [—] | 5.34 | −3.67 |
| Tensile modulus | [MPa] | 1300-1500 | 958 |
| Charpy NIS (+23° C.) | [kJ/m²] | 5 | 20 |

n.m. = not measured

The pellets of the mixed-plastic polypropylene blends PP blend and of the mixed-plastics polyethylene blend PE blend were aerated before use, to remove volatile organic components as described in EP 3 786 190 A1.

### c) Compounding of Inventive and Comparative Compositions

The inventive and comparative compositions were prepared based on the recipes indicated in Table 3 by compounding in a co-rotating twin-screw extruder Coperion ZSK 40 at 220° C.

In addition to the HECOs and the mixed-plastic polypropylene blend described above, the following commercially available components were also employed:
HDPE a high density polyethylene with the tradename of BorPure MB5568, commercially available from Borealis AG, having a melt flow rate of 0.8 g/10 min, a density of 956 kg/m³ and a tensile modulus of 1000 MPa
Plastomer an elastomeric ethylene-octene copolymer with a trade name of Engage 8180, commercially available from Dow Chemicals (USA), having an MFR₂ (190° C.) of 0.5 g/10 min and a density of 863 kg/m³.
Filler talc with a trade name of Jetfine 3CA, commercially available from Imerys (France), with median diameter d50 of 1.3 μm.
Black MB a polyethylene based masterbatch CBMB LD-09 A02 from Borealis AG (Norway). It contains 40 wt.-% of pigment.
Additives MB an additive masterbatch, consisting of 1.80 wt.-% of a carrier propylene homopolymer with a trade name of HC001 A, commercially available from Borealis AG (Austria), 0.10 wt.-% of an antioxidant with a trade name of Irgafos 168 (CAS-no. 31570-04-4), available from BASF AG (Germany), 0.25 wt.-% of an antioxidant with a trade name of Irganox 1076 (CAS-no. 2082-79-3), commercially available from BASF AG (Germany), 0.50 wt.-% of bisphenol A-epoxy resin with a trade name of Araldite GT 7072 ES (CAS-no. 25036-25-3), commercially available from Huntsman Corporation (USA), 2.00 wt.-% of silicon masterbatch i.e. dimethyl siloxane:polypropylene=50:50 from Dow Corning and 0.20 wt.-% of a UV-stabiliser masterbatch with a trade name of Cyasorb UV-3808PP5, commercially available from Cytec Industries, Inc. (USA)

The recipes of the inventive and comparative compositions are given in Table 3. The properties of the inventive and comparative compositions are given in Table 4.

TABLE 3
Recipes for inventive and comparative examples

| | | CE1 | CE2 | IE1 | IE2 | IE3 |
|---|---|---|---|---|---|---|
| HECO1 | [wt.-%] | 21.45 | 15.45 | 15.45 | 19.45 | 10.45 |
| HECO2 | [wt.-%] | 17.0 | 17.0 | 17.0 | 15.0 | 17.0 |
| PP Blend | [wt.-%] | 30.0 | 30.0 | 30.0 | 30.0 | 30.0 |
| PE Blend | [wt.-%] | — | — | 5.0 | 5.0 | 10.0 |
| HDPE | [wt.-%] | — | 5.0 | — | — | — |
| Plastomer | [wt.-%] | 10.0 | 10.0 | 10.0 | 8.0 | 10.0 |
| Filler | [wt.-%] | 15.0 | 16.0 | 16.0 | 16.0 | 16.0 |
| Additives MB | [wt.-%] | 5.05 | 5.05 | 5.05 | 5.05 | 5.05 |
| Black MB | [wt.-%] | 1.5 | 1.5 | 1.5 | 1.5 | 1.5 |

TABLE 4
Properties of the inventive and comparative compositions

| | | CE1 | CE2 | IE1 | IE2 | IE3 |
|---|---|---|---|---|---|---|
| MFR₂ | [g/10 min] | 11 | 14 | 12 | 11 | 8 |
| C2(total) | [wt.-%] | 16.0 | 15.0 | 21.0 | 20.9 | 25.7 |
| iV(total) | [dL/g] | 1.83 | 1.80 | 1.89 | 1.88 | 1.93 |
| SF | [wt.-%] | 24.0 | 25.0 | 24.5 | 24.5 | 23.6 |
| C2(SF) | [wt.-%] | 54 | 53 | 53 | 52 | 52 |
| iV(SF) | [dL/g] | 2.32 | 2.48 | 2.50 | 2.47 | 2.54 |
| CF | [wt.-%] | 76.0 | 75.0 | 75.5 | 75.5 | 76.4 |
| C2(CF) | [wt.-%] | 6.0 | 4.0 | 11.7 | n.m. | 19.3 |
| iV(CF) | [dL/g] | 1.67 | 1.61 | 1.68 | 1.67 | 1.75 |
| C2(SF)/C2(CF) | | 9.0 | 13.3 | 4.5 | n.m. | 2.7 |
| iV(SF)/iV(CF) | [—] | 1.34 | 1.54 | 1.49 | 1.48 | 1.45 |
| Flexural Modulus | [MPa] | 1735 | 1924 | 1743 | 1744 | 1627 |
| Tensile Modulus | [MPa] | 1738 | 1872 | 1688 | 1678 | 1576 |
| Tensile stress at yield | [MPa] | 21 | 21 | 21 | 21 | 20 |
| Elongation at break | [%] | 417 | 318 | 411 | 415 | 420 |
| Charpy NIS (+23° C.) | [kJ/m²] | 17 | 15 | 51 | 48 | 62 |
| Charpy NIS (−20° C.) | [kJ/m²] | 4.8 | 4.0 | 4.5 | 4.7 | 5.0 |
| Tensile Modulus * Charpy | [MPa * | 29546 | 28080 | 86088 | 80544 | 97712 |
| NIS (+23° C.) | kJ/m²] | | | | | |
| LBS | [μg/g] | 30 | 23 | 46 | 26 | 18 |
| HBS | [μg/g] | 153 | 117 | 207 | 143 | 128 |
| Fogging | [mg] | 0.48 | 0.48 | 0.39 | 0.37 | 0.40 |
| Scratch resistance (10N) | [—] | 0.65 | 1.52 | 0.9 | 1.09 | 0.69 |
| MAR resistance K09 (9N | [—] | 0.9 | 1.1 | 0.9 | 1.1 | 1.1 |
| in one direction) | | | | | | |
| Isotropic shrinkage | [%] | 0.99 | 0.98 | 0.99 | 0.98 | 0.98 |
| Shrinkage in flow | [%] | 0.85 | 0.85 | 0.85 | 0.83 | 0.82 |
| Shrinkage cross flow | [%] | 1.04 | 1.05 | 1.06 | 1.04 | 1.05 |

n.m. = not measured

The inventive compositions show an improved balance of properties in regard of stiffness and impact properties, which is illustrated the stiffness-impact coefficient (Tensile Modulus*Charpy NIS (+23° C.)), compared to the comparative examples.

The inventive examples additionally show a good processability (melt flow rate), scratch resistance, shrinkage and low emissions (LBS, HBS, fogging) and therefore qualify as injection moulding compositions for interior automotive applications.

The inventive examples show that comparable or even superior materials can be obtained by introducing 5 to 10 wt.-% of HDPE-based recyclate material thereby reaching high recyclate contents of 35 to 40 wt.-% o.

1. A composition suitable for automotive applications obtainable by blending at least components (A), (B), (C), (D), (E) and (F):
(A) from 5.0 to 40.0 wt.-%, preferably from 7.0 to 37.5 wt.-%, more preferably from 8.0 to 35.0 wt.-% of a first heterophasic propylene copolymer;
(B) from 10.0 to 20.0 wt.-%, preferably from 12.5 to 19.0 wt.-%, more preferably from 14.0 to 18.0 wt.-% of a second heterophasic propylene copolymer;
(C) from 15.0 wt.-% to 45.0 wt.-%, preferably from 17.5 to 42.5 wt.-%, more preferably from 20.0 to 40.0 wt.-% of a mixed-plastics polypropylene blend;
(D) from 2.5 wt.-% to 15.0 wt.-%, preferably from 3.5 to 12.5 wt.-%, more preferably from 4.0 to 11.0 wt.-% of a mixed-plastics polyethylene blend;
(E) from 2.5 wt.-% to 15.0 wt.-%, preferably from 3.5 to 12.5 wt.-%, more preferably from 4.0 to 11.0 wt.-% of an ethylene-based plastomer; and
(F) from 2.5 wt.-% to 25.0 wt.-%, preferably from 3.5 to 22.0 wt.-%, more preferably from 4.0 to 20.0 wt.-% of an inorganic filler;
wherein all percentages refer to the total composition, and
wherein the first heterophasic propylene copolymer (A) comprises a matrix phase and an elastomer phase dispersed therein and has
a melt flow rate (MFR₂), determined according to ISO 1133 at 230° C. and 2.16 kg, in the range from 90 to 250 g/10 min; and
an intrinsic viscosity, determined according to DIN ISO 1628/1, of the soluble fraction (iV(SF)), according to CRYSTEX QC analysis, in the range from 2.00 to 4.00 dl/g;
the second heterophasic propylene copolymer (B) comprises a matrix phase and an elastomer phase dispersed therein and has
a melt flow rate MFR₂, determined according to ISO 1133 at 230° C. and 2.16 kg, in the range from 3.0 to 30 g/10 min and
an intrinsic viscosity, determined according to DIN ISO 1628/1, of the soluble fraction (iV(SF)), according to CRYSTEX QC analysis, in the range from 4.10 to 10.00 dl/g;
the mixed-plastics polypropylene blend (C) has
a crystalline fraction (CF) content determined according to CRYSTEX QC analysis in the range from 85.0 to 96.0 wt.-%, preferably in the range from 86.5 to 95.5 wt.-%, and
a soluble fraction (SF) content determined according to CRYSTEX QC analysis in the range from 4.0 to 15.0 wt.-%, preferably in the range from 4.5 to 13.5 wt.-%, whereby
the crystalline fraction (CF) has an ethylene content (C2(CF)), as determined by FT-IR spectroscopy calibrated by quantitative ¹³C-NMR spectroscopy, in the range from 1.0 to 10.0 wt.-%, preferably in the range of 1.5 to 9.5 wt.-%; and
the soluble fraction (SF) has an intrinsic viscosity (iV(SF)) in the range from 0.9 to 2.1 dl/g, preferably in the range of 1.0 to 2.0 dl/g, more preferably in the range of 1.1 to 1.9 dl/g;
the mixed-plastics polyethylene blend (D) has
a melt flow rate MFR₂ of 0.1 to 5.0 g/10 min, preferably 0.2 to 2.5 g/10 min, determined according to ISO 1133 at 190° C. and 2.16 kg; and
a density of from 970 to 990 kg/m³, preferably from 975 to 985 kg/m³, determined according to ISO 1183;
the ethylene based plastomer (E) being a copolymer of ethylene with comonomer units selected from alpha-olefins having from 3 to 12 carbon atoms, preferably from alpha-olefins having from 4 to 10 carbon atoms, most preferably from 1-octene, has
a melt flow rate MFR₂ of 0.2 to 2.5 g/10 min, preferably 0.3 to 2.0 g/10 min, determined according to ISO 1133 at 190° C. and 2.16 kg; and
a density of from 850 to 870 kg/m³, preferably from 855 to 865 kg/m³, determined according to ISO 1183; and
the composition has a melt flow rate MFR₂, determined according to ISO 1133 at 230° C. and 2.16 kg, in the range from 5.0 to less than 20.0 g/10 min, preferably from 6.5 to 19.0 g/10 min, more preferably from 7.5 to 17.5 g/10 min.

2. The composition according to claim 1, wherein the inorganic filler (E) is talc having
a median particle size d₅₀ before compounding of 0.3 to 30.0 micrometers, preferably 1.5 to 15.0 micrometers; and/or
a top-cut particle size d95 before compounding of 1.0 to 50.0 micrometers, preferably 5.0 to 35.0 micrometers.

3. The composition according to claim 1 having a crystalline fraction (CF) and a soluble fraction (SF) in the CRYSTEX QC analysis, wherein
a crystalline fraction (CF) content determined according to CRYSTEX QC analysis is in the range from 65.0 to 85.0 wt.-%, preferably 70.0 to 80.0 wt.-%, and
a soluble fraction (SF) content determined according to CRYSTEX QC analysis is in the range from 15.0 to 35.0 wt.-%, preferably 20.0 to 30.0 wt.-%, whereby
the crystalline fraction (CF) has an ethylene content (C2(CF)), as determined by FT-IR spectroscopy calibrated by quantitative ¹³C-NMR spectroscopy, in the range from 7.5 to 25.0 wt.-%, preferably 9.0 to 22.5 wt.-%; and/or
the crystalline fraction (CF) has an intrinsic viscosity (iV(CF)), determined according to DIN ISO 1628/1, of less than 2.0 dl/g, preferably from 1.2 to 1.9 dl/g;
and/or
the soluble fraction (SF) has an ethylene content (C2(SF)), as determined by FT-IR spectroscopy calibrated by quantitative ¹³C-NMR spectroscopy, in the range from 45 to 65 wt.-%, preferably 50 to 60 wt.-%; and/or
the soluble fraction (SF) has an intrinsic viscosity (iV(SF)), determined according to DIN ISO 1628/1, of more than 2.1 dl/g, preferably from 2.2 to 3.5 dl/g; and/or
the composition has a ratio of the intrinsic viscosity of the soluble fraction to the intrinsic viscosity of the crystalline fraction (iV(SF)/iV(CF)) of more than 1.0, preferably from 1.10 to 2.00, more preferably from 1.25 to 1.75; and/or
the composition has a ratio of the ethylene content (of the soluble fraction to the ethylene content of the crystalline fraction (C2(SF)/C2(CF)) of not more than 7.5, preferably from 1.5 to 6.5, more preferably from 2.5 to 6.0.

4. The composition according to claim 1 having a total intrinsic viscosity iV, determined according to DIN ISO 1628/1, of from 1.40 to 2.40 dl/g, preferably from 1.60 to 2.20 dl/g.

5. The composition according to claim 1 having a total ethylene content, as determined by FT-IR spectroscopy calibrated by quantitative ¹³C-NMR spectroscopy, in the range from 17.5 to 30.0 wt.-%, preferably 19.0 to 25.0 wt.-%.

6. The composition according to claim 1 having a flexural modulus of from 1400 MPa to 2200 MPa, preferably from 1500 MPa to 2000 MPa, determined according to ISO 178.

7. The composition according to claim 1 having a tensile modulus of from 1200 MPa to 2200 MPa, preferably from 1300 MPa to 2000 MPa and/or a tensile stress at yield of from 15 to 35 MPa, preferably from 18 to 30 MPa and/or an elongation at break of from 350 to 500%, preferably from 375 to 475%, all determined according to ISO 527-2.

8. The composition according to claim 1 having a Charpy Notched Impact Strength at 23° C. of from 30.0 kJ/m² to 75.0 kJ/m², preferably from 40.0 to 70.0 kJ/m² and/or Charpy Notched Impact Strength at −20° C. of from 2.5 kJ/m² to 10.0 kJ/m², preferably from 3.5 to 7.5 kJ/m², determined according to ISO 179 1 eA at +23° C. or −20° C.

9. The composition according to claim 1, having a stiffness-impact coefficient Tensile Modulus*Charpy NIS (+23° C.) of more than 40000 MPa*kJ/m², preferably from 50000 to 150000 MPa*kJ/m², more preferably from 67500 to 135000 MPa*kJ/m², still more preferably from 75000 to 125000 MPa*kJ/m².

10. The composition according to claim 1 having one or more preferably all of the following properties
a content of volatile organic compounds (LBS), determined by screening of organic emissions by thermo-desorption analysis, in the range from 5 to 100 μg/g, preferably from 10 to 75 μg/g;
a content of HBS, determined by screening of organic emissions by thermo-desorption analysis, in the range from 50 to 300 μg/g, preferably from 100 to 250 μg/g; and
an amount of fogging, determined according to the gravimetric method DI 75201:2011-11, method B, in the range from 0.05 to 0.75 mg, preferably from 0.15 to 0.50 mg.

11. An article comprising the composition according to claim 1 in an amount of from 90 wt.-% to 100 wt.-%.

12. The article according to claim 11 being a moulded article, preferably a moulded automotive article.

13. The article according to claim 11 having a scratch resistance at 10 N in the range from 0.00 to 1.40, preferably from 0.10 to 1.25 and/or a MAR resistance in one direction at 9 N in the range from 0.00 to 1.40, preferably from 0.25 to 1.25.

14. The article according to claim 11 having an isotropic area shrinkage of from 0.25 to 1.25%, preferably from 0.50 to 1.10% and/or a shrinkage in flow of from 0.25 to 1.15%, preferably from 0.50 to 1.00% and/or a shrinkage cross flow of from 0.35 to 1.35%, preferably from 0.60 to 1.20%.

15. (canceled)
